(19) United States
(12) Patent Application Publication
(10) Pub. No.: US 2013/0218559 A1
(43) Pub. Date: Aug. 22, 2013

(54) NOISE REDUCTION APPARATUS, AUDIO INPUT APPARATUS, WIRELESS COMMUNICATION APPARATUS, AND NOISE REDUCTION METHOD

(71) Applicant: JVC KENWOOD Corporation, (US)

(72) Inventor: Takaaki YAMABE, Yokohama-Shi (JP)

(73) Assignee: JVC KENWOOD CORPORATION, Yokohama-Shi (JP)

(21) Appl. No.: 13/768,174

(22) Filed: Feb. 15, 2013

(30) Foreign Application Priority Data
Feb. 16, 2012 (JP) JP 2012-031711

(51) Int. Cl. G10L 21/0216

(52) U.S. Cl. CPC G10L 21/0216
USPC 704/226

(57) ABSTRACT

A speech segment of a voice sound is detected based on a first sound pick-up signal obtained based on the voice sound. A voice incoming direction of the voice sound is determined using the first sound pick-up signal and a second sound pick-up signal obtained based on a picked-up sound. A noise reduction process is performed to reduce a noise component carried by the first sound pick-up signal by using the second sound pick-up signal, wherein a noise reduction amount adjusted in accordance with the voice incoming direction is used in the noise reduction process.

### CROSS-REFERENCE TO RELATED APPLICATIONS

This application is based on and claims the benefit of priority from the prior Japanese Patent Application No. 2012-031711 filed on Feb. 16, 2012, the entire contents of which are incorporated herein by reference.

### BACKGROUND OF THE INVENTION

The present invention relates to a noise reduction apparatus, an audio input apparatus, a wireless communication apparatus, and a noise reduction method.

There are known techniques to reduce noise components carried by a voice signal so that a voice sound carried by the voice signal is reproduced to be clearly heard. In a known technique, a noise component carried by a voice signal is eliminated by subtracting a noise signal obtained by a microphone for picking up mainly noise sounds from a voice signal obtained by a microphone for picking up mainly voice sounds.

In a known noise reduction technique, unnecessary sounds are only reduced while desired sounds are maintained. In another known noise reduction technique, the clearness of voice sounds is enhanced that is otherwise lowered by an adaptive filter for noise reduction.

In the case of noise reduction using a voice signal that mainly carries voice components and a noise signal that mainly carries noise components may cause mixing of voice components into the noise signal, depending on an environment where the noise reduction is performed. The mixture of the voice components into the noise signal may further cause cancellation of voice components carried by the voice signal in addition to the noise components, resulting in reduction in sound level of an signal after the noise reduction.

### SUMMARY OF THE INVENTION

A purpose of the present invention is to provide a noise reduction apparatus, an audio input apparatus, a wireless communication apparatus, and a noise reduction method that can restrict the reduction in sound level.

The present invention provides a noise reduction apparatus comprising: a speech segment determiner configured to detect a speech segment of a voice sound based on a first sound pick-up signal obtained based on the voice sound; a voice direction detector configured to determine a voice incoming direction of the voice sound using the first sound pick-up signal and a second sound pick-up signal obtained based on a picked-up sound; and a noise reduction processor configured to perform a noise reduction process to reduce a noise component carried by the first sound pick-up signal by using the second sound pick-up signal, wherein a noise reduction amount adjusted in accordance with the voice incoming direction is used in the noise reduction process.

Moreover, the present invention provides an audio input apparatus comprising: a first face and an opposite second face that is apart from the first face with a specific distance; a first microphone and a second microphone provided on the first face and the second face, respectively; a speech segment determiner configured to detect a speech segment of a voice sound based on a first sound pick-up signal obtained based on the voice sound picked up by the first microphone; a voice direction detector configured to determine a voice incoming direction of the voice sound using the first sound pick-up signal and a second sound pick-up signal obtained based on a sound picked up by the second microphone; and a noise reduction processor configured to perform a noise reduction process to reduce a noise component carried by the first sound pick-up signal by using the second sound pick-up signal, wherein a noise reduction amount adjusted in accordance with the voice incoming direction is used in the noise reduction process.

Furthermore, the present invention provides a wireless communication apparatus comprising: a first face and an opposite second face that is apart from the first face with a specific distance; a first microphone and a second microphone provided on the first face and the second face, respectively; a speech segment determiner configured to detect a speech segment of a voice sound based on a first sound pick-up signal obtained based on the voice sound picked up by the first microphone; a voice direction detector configured to determine a voice incoming direction of the voice sound using the first sound pick-up signal and a second sound pick-up signal obtained based on a sound picked up by the second microphone; and a noise reduction processor configured to perform a noise reduction process to reduce a noise component carried by the first sound pick-up signal by using the second sound pick-up signal, wherein a noise reduction amount adjusted in accordance with the voice incoming direction is used in the noise reduction process.

Still furthermore, the present invention provides a noise reduction method comprising the steps of: detecting a speech segment of a voice sound based on a first sound pick-up signal obtained based on the voice sound; determining a voice incoming direction of the voice sound using the first sound pick-up signal and a second sound pick-up signal obtained based on a picked-up sound; and performing a noise reduction process to reduce a noise component carried by the first sound pick-up signal by using the second sound pick-up signal, wherein a noise reduction amount adjusted in accordance with the voice incoming direction is used in the noise reduction process.

### BRIEF DESCRIPTION OF DRAWINGS

FIG. 1 is a basic block diagram showing the configuration of a noise reduction apparatus according to an embodiment of the present invention;

FIG. 2 is a block diagram schematically showing the configuration of one example of a speech segment determiner installed in the noise reduction apparatus according to the embodiment of the present invention;

FIG. 3 is a block diagram schematically showing the configuration of another example of a speech segment determiner installed in the noise reduction apparatus according to the embodiment of the present invention;

FIG. 4 is a block diagram schematically showing the configuration of one example of a voice direction detector installed in the noise reduction apparatus according to the embodiment of the present invention;

FIG. 5 is a block diagram schematically showing the configuration of another example of a voice direction detector installed in the noise reduction apparatus according to the embodiment of the present invention;

FIG. 6 is a block diagram schematically showing the configuration of an example of a noise reduction processor installed in the noise reduction apparatus according to the embodiment of the present invention;

FIG. 7 is a view illustrating a noise reduction process of the noise reduction apparatus according to the embodiment of the present invention;

FIG. 8 is a detailed basic block diagram showing the configuration of the noise reduction apparatus 1 shown in FIG. 1.

FIG. 9 is a view showing the relationship between the position of a voice source and the sound level of an output signal after a noise reduction process by a known noise reduction apparatus;

FIG. 10 is a view showing the relationship between the position of a voice source with respect to a main microphone and the sound level of a sound pick-up signal obtained based on a sound picked up by the main microphone;

FIG. 11 is a view showing the relationship between the position of a voice source and the sound level of an output signal after the noise reduction process by the noise reduction apparatus according to the embodiment of the present invention;

FIG. 12 shows exemplary noise reduction-amount adjustment values with respect to the location of a voice source in the noise reduction apparatus according to the embodiment of the present invention;

FIG. 13 is a schematic illustration of an audio input apparatus having the noise reduction apparatus according to the embodiment of the present invention; and

FIG. 14 is a schematic illustration of a wireless communication apparatus having the noise reduction apparatus according to the embodiment of the present invention.

### DETAILED DESCRIPTION OF PREFERRED EMBODIMENTS

Embodiments of a noise reduction apparatus, an audio input apparatus, a wireless communication apparatus, and a noise reduction method according the present invention will be explained with reference to the attached drawings.

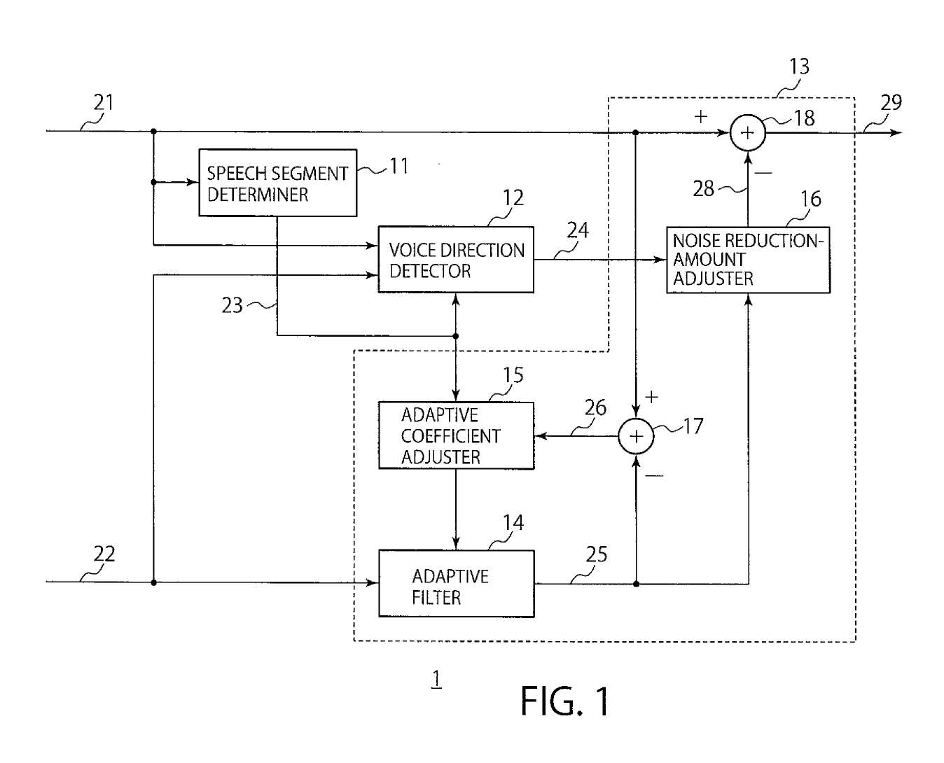

FIG. 1 is a basic block diagram showing the configuration of a noise reduction apparatus 1 according to an embodiment of the present invention.

The noise reduction apparatus 1 shown in FIG. 1 is provided with a speech segment determiner 11, a voice direction detector 12, and a noise reduction processor 13. The noise reduction processor 13 has an adaptive filter 14, an adaptive coefficient adjuster 15, a noise reduction-amount adjuster 16, and adders (arithmetic units) 17 and 18.

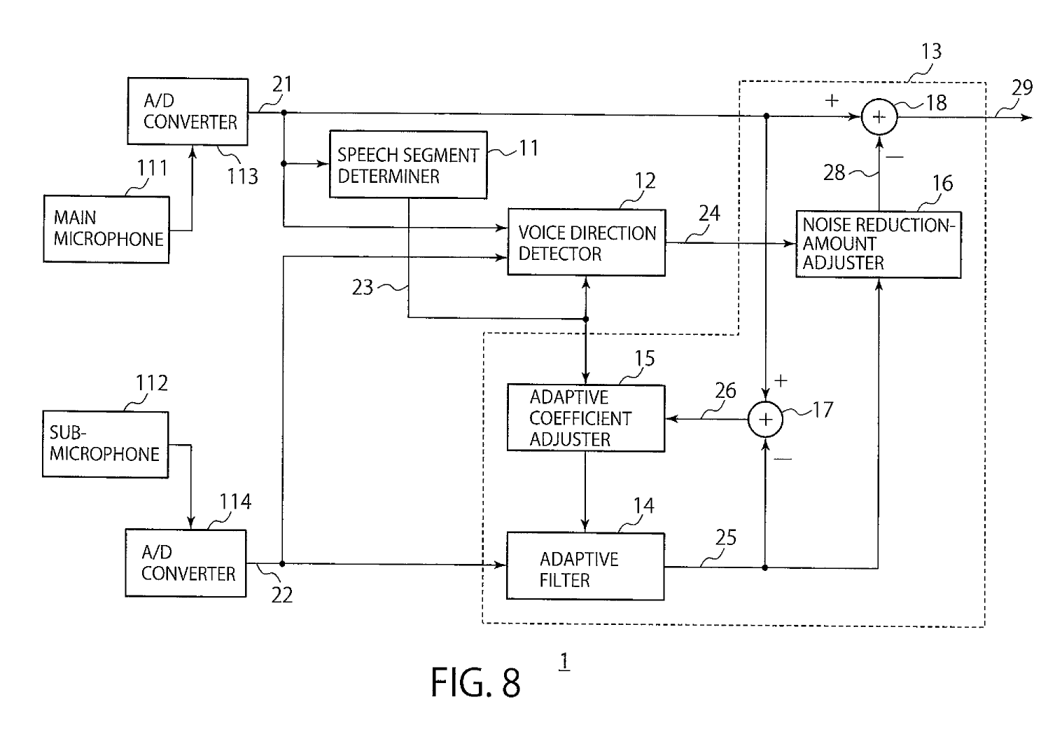

FIG. 8 is a detailed basic block diagram showing the configuration of the noise reduction apparatus 1 shown in FIG. 1.

As shown in FIG. 8, in addition to the speech segment determiner 11, the voice direction detector 12, and the noise reduction processor 13, the noise reduction apparatus 1 is provided with a main microphone 111, a sub-microphone 112, and A/D converters 113 and 114.

The noise reduction apparatus 1 according to an embodiment of the present invention will be described with respect to FIG. 1 or 8 according to the necessity.

In FIG. 1, the noise reduction apparatus 1 receives a sound pick-up signal 21 and a sound pick-up signal 22 obtained based on sounds picked up by microphones and performs a noise reduction process using the signals 21 and 22 to output a noise-reduced signal as an output signal 29. The sound pick-up signal 21 mainly carries a voice component and referred to as a voice signal, hereinafter. The sound pick-up signal 22 mainly carries a noise component and is referred to as a noise-dominated signal, hereinafter.

In FIG. 8, the main microphone 111 and the sub-microphone 112 pick up a sound including a voice component (speech segment) and/or a noise component. In detail, the main microphone 111 is a voice-component pick-up microphone that picks up a sound that mainly includes a voice component and converts the sound into an analog signal that is output to the A/D converter 113. The sub-microphone 112 is a noise-component pick-up microphone that picks up a sound that mainly includes a noise component and converts the sound into an analog signal that is output to the A/D converter 114. A noise component picked up by the sub-microphone 112 is used for reducing a noise component included in a sound picked up by the main microphone 111.

In FIG. 8, the A/D converter 113 samples an analog signal output from the main microphone 111 at a predetermined sampling rate and converts the sampled analog signal into a digital signal to generate a sound pick-up signal 21. The A/D converter 114 samples an analog signal output from the sub-microphone 112 at a predetermined sampling rate and converts the sampled analog signal into a digital signal to generate a sound pick-up signal 22.

In this embodiment, a frequency band for a voice sound input to the main microphone 111 and the sub-microphone 112 is roughly in the range from 100 Hz to 4,000 Hz, for example. In this frequency band, the A/D converters 113 and 114 convert an analog signal carrying a voice component into a digital signal at a sampling frequency in the range from about 8 kHz to 12 kHz.

As shown in FIG. 1, the sound pick-up signal 21 is supplied to the speech segment determiner 11, the voice direction detector 12, and the adders 17 and 18 of the noise reduction processor 13. The sound pick-up signal 22 is supplied to the voice direction detector 12 and the adaptive filter 14 of the reduction processor 13.

The speech segment determiner 11 detect a speech segment, or determines whether or not a sound picked up the main microphone 111 is a speech segment (voice component) based on the sound pick-up signal 21 output from the A/D converter 113. When it is determined that a sound picked up the main microphone 111 is a speech segment, the speech segment determiner 11 outputs speech segment information 23 to the voice direction detector 12 and the adaptive filter adjuster 15. The speech segment determiner 11 may determine that a sound picked up the main microphone 111 is a speech segment when a feature value that indicates a feature of a voice component carried by the sound pick-up signal 21 is equal to or larger than a specific threshold value that can be set freely. The feature value is, for example, a signal-to-noise ratio, an energy ratio, the number of subband pairs, etc. which will be explained later.

The speech segment determiner 11 can employ any speech segment determination techniques. However, when the noise reduction apparatus 1 is used in an environment of high noise level, highly accurate speech segment determination is required. In such a case, for example, a speech segment determination technique I described in U.S. patent application Ser. No. 13/302,040 or a speech segment determination technique II described in U.S. patent application Ser. No. 13/364,016 can be used. With the speech segment determination technique I or II, a human voice is mainly detected and a speech segment is detected accurately.

The speech segment determination technique I focuses on frequency spectra of a vowel sound that is a main component of a voice sound, to detect a speech segment. In detail, in the speech segment determination technique I, a signal-to-noise ratio is obtained between a peak level of a vowel-sound frequency component and a noise level appropriately set in each frequency band and it is determined whether the obtained signal-to-noise ratio is at least a specific ratio for at least a specific number of peaks, thereby detecting a speech segment.

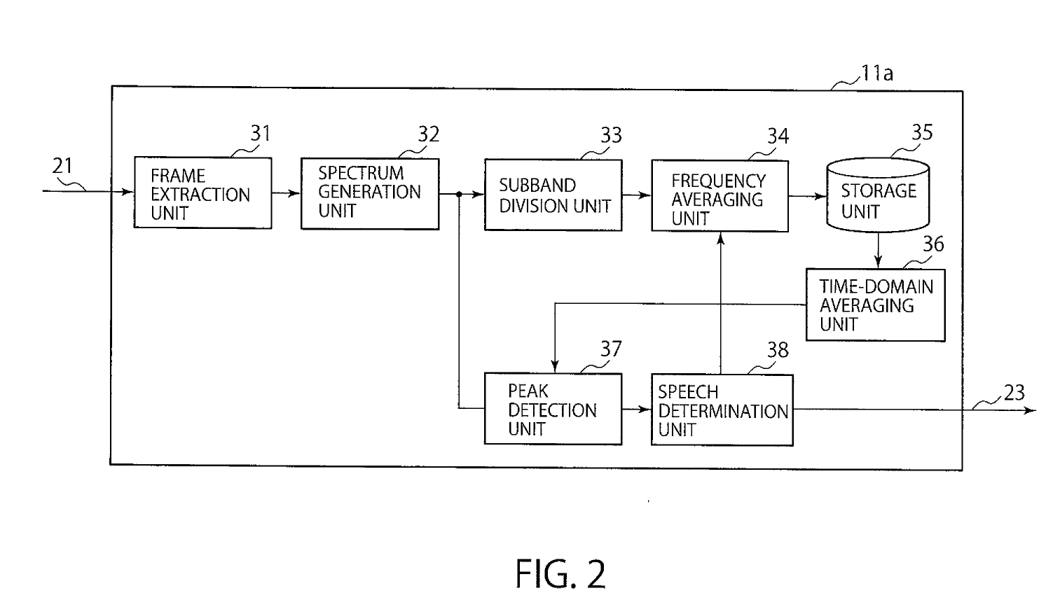

FIG. 2 is a block diagram schematically showing the configuration of a speech segment determiner 11a employing the speech segment determination technique I.

The speech segment determiner 11a is provided with a frame extraction unit 31, a spectrum generation unit 32, a subband division unit 33, a frequency averaging unit 34, a storage unit 35, a time-domain averaging unit 36, a peak detection unit 37, and a speech determination unit 38.

In FIG. 2, the sound pick-up signal 21 output from the AD converter 113 (FIG. 8) is input to the frame extraction unit 31. The frame extraction unit 31 extracts a signal portion for each frame having a specific duration corresponding to a specific number of samples from the input sound pick-up signal 21, to generate per-frame input signals. The frame extraction unit 31 sends the generated per-frame input signals to the spectrum generation unit 32 one after another.

The spectrum generation unit 32 performs frequency analysis of the per-frame input signals to convert the per-frame input signals in the time domain into per-frame input signals in the frequency domain, thereby generating a spectral pattern. The spectral pattern is the collection of spectra having different frequencies over a specific frequency band. The technique of frequency conversion of per-frame signals in the time domain into the frequency domain is not limited to any particular one. Nevertheless, the frequency conversion requires high frequency resolution enough for recognizing speech spectra. Therefore, the technique of frequency conversion in the speech segment determiner 11a may be FFT (Fast Fourier Transform), DCT (Discrete Cosine Transform), etc. that exhibit relatively high frequency resolution.

In FIG. 2, the spectrum generation unit 32 generates a spectral pattern in the range from at least 200 Hz to 700 Hz.

Spectra (referred to as formant, hereinafter) represent the feature of a voice sound and are to be detected in determining speech segments by the speech determination unit 38, which will be described later. The spectra generally involve a plurality of formants from the first formant corresponding to a fundamental pitch to the n-th formant (n being a natural number) corresponding to a harmonic overtone of the fundamental pitch. The first and second formants mostly exist in a frequency band below 200 Hz. This frequency band involves a low-frequency noise component with relatively high energy. Thus, the first and second formants tend to be embedded in the low-frequency noise component. A formant at 700 Hz or higher has low energy and hence also tends to be embedded in a noise component. Therefore, the determination of speech segments can be efficiently performed with a spectral pattern in a narrow range from 200 Hz to 700 Hz.

A spectral pattern generated by the spectrum generation unit 32 is sent to the subband division unit 33 and the peak detection unit 37.

The subband division unit 33 divides the spectral pattern into a plurality of subbands each having a specific bandwidth, in order to detect a spectrum unique to a voice sound for each appropriate frequency band. The specific bandwidth treated by the subband division unit 33 is in the range from 100 Hz to 150 Hz in this embodiment. Each subband covers about ten spectra.

The first formant of a voice sound is detected at a frequency in the range from about 100 Hz to 150 Hz. Other formants that are harmonic overtone components of the first formant are detected at frequencies, the multiples of the frequency of the first formant. Therefore, each subband involves about one formant in a speech segment when it is set to the range from 100 Hz to 150 Hz, thereby achieving accurate determination of a speech segment in each subband. On the other hand, if a subband is set wider than the range discussed above, it may involve a plurality of peaks of voice energy. Thus, a plurality of peaks may inevitably be detected in this single subband, which have to be detected in a plurality of subbands as the features of a voice sound, causing low accuracy in the determination of a speech segment. A subband set narrower than the range discussed above dose not improve the accuracy in the determination of a speech segment but causes a heavier processing load.

The frequency averaging unit 34 acquires average energy for each subband sent from the subband division unit 33. The frequency averaging unit 34 obtains the average of the energy of all spectra in each subband. Not only the spectral energy, the frequency averaging unit 34 can treat the maximum or average amplitude (the absolute value) of spectra for a smaller computation load.

The storage unit 35 is configured with a storage medium such as a RAM (Random Access Memory), an EEPROM (Electrically Erasable and Programmable Read Only Memory), a flash memory, etc. The storage unit 35 stores the average energy per subband for a specific number of frames (the specific number being a natural number N) sent from the frequency averaging unit 34. The average energy per subband is sent to the time-domain averaging unit 36.

The time-domain averaging unit 36 derives subband energy that is the average of the average energy derived by the frequency averaging unit 34 over a plurality of frames in the time domain. The subband energy is the average of the average energy per subband over a plurality of frames in the time domain. In the speech segment determiner 11a, the subband energy is treated as a standard noise level of noise energy in each subband. The average energy can be averaged to be the subband energy in the time domain with less drastic change. The time-domain averaging unit 36 performs a calculation according to an equation (1) shown below:

$$Eavr = {\sum }_{i = 0}^{N} \frac{E ( i )}{N} \qquad ( 1 )$$

where Eavr and E(i) are: the average of average energy over N frames; and average energy in each frame, respectively.

Instead of the subband energy, the time-domain averaging unit 36 may acquire an alternative value through a specific process that is applied to the average energy per subband of an immediate-before frame (which will be explained later) using a weighting coefficient and a time constant. In this specific process, the time-domain averaging unit 36 performs a calculation according to equations (2) and (3) shown below:

$$Eavr 2 = \frac{E\_last \times α + E\_cur \times β}{T} \qquad ( 2 )$$

where Eavr2, E_last, and E_cur are: an alternative value for subband energy; subband energy in an immediate-before frame that is just before a target frame that is subjected to a speech-segment determination process; and average energy in the target frame, respectively; and

T=α+β (3)

where α and β are a weighting coefficient for E_last and E_cur, respectively, and T is a time constant.

Subband energy (a noise level for each subband) is stationary, hence is not necessarily quickly included in the speech-segment determination process for a target frame. Moreover, there is a case where, for a per-frame input signal that is determined as a speech segment by the speech determination unit 38, as described later, the time-domain averaging unit 36 does not include the energy of a speech segment in the derivation of subband energy or adjusts the degree of inclusion of the energy in the subband-energy derivation. For this purpose, subband energy is included in the speech-segment determination process for a target frame after the speech-segment determination for the frame just before the target frame at the speech determination unit 38. Accordingly, the subband energy derived by the time-domain averaging unit 36 is used in the segment determination at the speech determination unit 38 for a frame next to the target frame.

The peak detection unit 37 derives an energy ratio (SNR: Signal to Noise Ratio) of the energy in each spectrum in the spectral pattern (sent from the spectrum generation unit 32) to the subband energy (sent from the time-domain averaging unit 36) in a subband in which the spectrum is involved.

In detail, the peak detection unit 37 performs a calculation according to an equation (4) shown below, using the subband energy for which the average energy per subband has been included in the subband-energy derivation in the frame just before a target frame, to derive SNR per spectrum

$$S N R = \frac{E\_spec}{Noise\_Level} \qquad ( 4 )$$

where SNR, E_spec, and Noise_Level are: a signal to noise ratio (a ratio of spectral energy to subband energy; spectral energy; and subband energy (a noise level in each subband), respectively.

It is understood from the equation (4) that a spectrum with SNR of 2 has a gain of about 6 dB in relation to the surrounding average spectra.

Then, the peak detection unit 37 compares SNR per spectrum and a predetermined first threshold level to determine whether there is a spectrum that exhibits a higher SNR than the first threshold level. If it is determined that there is a spectrum that exhibits a higher SNR than the first threshold level, the peak detection unit 37 determines the spectrum as a formant and outputs formant information indicating that a formant has been detected, to the speech determination unit 38.

On receiving the formant information, the speech determination unit 38 determines whether a per-frame input signal of the target frame is a speech segment, based on a result of determination at the peak detection unit 37. In detail, the speech determination unit 38 determines that a per-frame input signal is a speech segment when the number of spectra of this per-frame input signal that exhibit a higher SNR than the first threshold level is equal to or larger than a first specific number.

Suppose that average energy is derived for all frequency bands of a spectral pattern and averaged in the time domain to acquire a noise level. In this case, even if there is a spectral peak (formant) in a band with a low noise level and that should be determined as a speech segment, the spectrum is inevitably determined as a non-speech segment when compared to a high noise level of the average energy. This results in erroneous determination that a per-frame input signal that carries the spectral peak is a non-speech segment.

To avoid such erroneous determination, the speech segment determiner 11a derives subband energy for each subband. Therefore, the speech determination unit 38 can accurately determine whether there is a formant in each subband with no effects of noise components in other subbands.

Moreover, the speech segment determiner 11a employs a feedback mechanism with average energy of spectra in subbands in the time domain derived for a current frame, for updating subband energy for the speech-segment determination process to the frame following to the current frame. The feedback mechanism provides subband energy that is the energy averaged in the time domain, that is stationary noise energy.

As discussed above, there is a plurality of formants from the first formant to the n-th formant that is a harmonic overtone component of the first formant. Therefore, there is a case where, even if some formants are embedded in noises of a higher level, or higher subband energy in any subband, other formants are detected. In particular, surrounding noises are converged into a low frequency band. Therefore, even if the first formant (corresponding to a fundamental pitch) and the second formant (corresponding to the second harmonic of the fundamental pitch) are embedded in low frequency noises, there is a possibility that formants of the third harmonic or higher are detected.

Accordingly, the speech determination unit 38 can determine that a per-frame input signal is a speech segment when the number of spectra of this per-frame input signal that exhibit a higher SNR than the first threshold level is equal to or larger than the first specific number. This achieves noise-robust speech segment determination.

The peak detection unit 37 may vary the first threshold level depending on subband energy and subbands. For example, the peak detection unit 37 may be equipped with a table listing threshold levels corresponding to a specific range of subbands and subband energy. Then, when a subband and subband energy are derived for a spectrum to be subjected to the speech determination, the peak detection unit 37 looks up the table and sets a threshold level corresponding to the derived subband and subband energy to the first threshold level. With this table in the peak detection unit 37, the speech determination unit 38 can accurately determine a spectrum as a speech segment in accordance with the subband and subband energy, thus achieving further accurate speech segment determination.

Moreover, when the number of spectra of a per-frame input signal that exhibit a higher SNR than the first threshold level reaches the first specific number, the peak detection unit 37 may stop the SNR derivation and the comparison between SNR and the first threshold level. This makes possible a smaller processing load to the peak detection unit 37.

Moreover, the speech determination unit 38 may output a result of the speech segment determination process to the time-domain averaging unit 36 to avoid the effects of voices to subband energy to raise the reliability of speech segment determination, as explained below.

There is a high possibility that a spectrum is a formant when the spectrum exhibits a higher SNR than the first threshold level. Moreover, voices are produced by the vibration of the vocal cords, hence there are energy components of the voices in a spectrum with a peak at the center frequency and in the neighboring spectra. Therefore, it is highly likely that there are also energy components of the voices on spectra before and after the neighboring spectra. Accordingly, the time-domain averaging unit 36 excludes these spectra at once to eliminate the effects of voices from the derivation of subband energy.

Moreover, if noises that exhibit an abrupt change are involved in a speech segment and a spectrum with the noises is included in the derivation of subband energy, it gives adverse effects to the estimation of noise level. However, the time-domain averaging unit 36 can also detect and remove such noises in addition to a spectrum that exhibits a higher SNR than the first threshold level and surrounding spectra.

In detail, the speech determination unit 38 outputs information on a spectrum exhibiting a higher SNR than the first threshold level to the time-domain averaging unit 36. This is not shown in FIG. 2 because of an option. Then, the time-domain averaging unit 36 derives subband energy per subband based on the energy obtained by multiplying average energy by an adjusting value of 1 or smaller. The average energy to be multiplied by the adjusting value is the average energy of a subband involving a spectrum that exhibits a higher SNR than the first threshold level or of all subbands of a per-frame input signal that involves such a spectrum of a high SNR.

The reason for multiplication of the average energy by the adjusting value is that the energy of voices is relatively greater than that of noises, and hence subband energy cannot be correctly derived if the energy of voices is included in the subband energy derivation.

The time-domain averaging unit 36 with the multiplication described above can derive subband energy correctly with less effect of voices.

The speech determination unit 38 may be equipped with a table listing adjusting values of 1 or smaller corresponding to a specific range of average energy so that it can look up the table to select an adjusting value depending on the average energy. Using the adjusting value from this table, the time-domain averaging unit 36 can decrease the average energy appropriately in accordance with the energy of voices.

Moreover, the technique described below may be employed in order to include noise components in a speech segment in the derivation of subband energy depending on the change in magnitude of surrounding noises in the speech segment.

In detail, the frequency averaging unit 34 excludes a particular spectrum or particular spectra from the average-energy deviation. The particular spectrum is a spectrum that exhibits a higher SNR than the first threshold level. The particular spectra are a spectrum that exhibits a higher SNR than the first threshold level and the neighboring spectra of this spectrum.

In order to perform the derivation of average energy with the exclusion of spectra described above, the speech determination unit 38 outputs information on a spectrum exhibiting a higher SNR than the first threshold level to the frequency averaging unit 34. Then, the frequency averaging unit 34 excludes a particular spectrum or particular spectra from the average-energy derivation. The particular spectrum is a spectrum that exhibits a higher SNR than the first threshold level. The particular spectra are a spectrum that exhibits a higher SNR than the first threshold level and the neighboring spectra of this spectrum. And, the frequency averaging unit 34 derives average energy per subband for the remaining spectra. The derived average energy is stored in the storage unit 35. Based on the stored average energy, the time-domain averaging unit 36 derives subband energy.

In the speech segment determiner 11a, the speech determination unit 38 outputs information on a spectrum exhibiting a higher SNR than the first threshold level to the frequency averaging unit 34. Then, the frequency averaging unit 34 excludes particular average energy from the average-energy derivation. The particular average energy is the average energy of a spectrum that exhibits a higher SNR than the first threshold level or the average energy of this spectrum and the neighboring spectra. And, the frequency averaging unit 34 derives average energy per subband for the remaining spectra. The derived average energy is stored in the storage unit 35.

The time-domain averaging unit 36 acquires the average energy stored in the storage unit 35 and also the information on the spectra that exhibit a higher SNR than the first threshold level. Then, the time-domain averaging unit 36 derives subband energy for the current frame, with the exclusion of particular average energy from the averaging in the time domain (in the subband-energy derivation). The particular average energy is the average energy of a subband involving a spectrum that exhibits a higher SNR than the first threshold level or the average energy of all subbands of a per-frame input signal that involves a spectrum that exhibits a higher energy ratio than the first threshold level. The time-domain averaging unit 36 keeps the derived subband energy for the frame that follows the current frame.

In this case, when using the equation (1), the time-domain averaging unit 36 disregards the average energy in a subband that is to be excluded from the subband-energy derivation or in all subbands of a per-frame input signal that involves a subband that is to be excluded from the subband-energy derivation and derives subband energy for the succeeding subbands. When using the equation (2), the time-domain averaging unit 36 temporarily sets T and 0 to α and β, respectively, in substituting the average energy in the subband or in all subbands discussed above, for E_cur.

As discussed above, there is a high possibility that a spectrum is a formant and also the surrounding spectra are formants when this spectrum exhibits a higher SNR than the first threshold level. The energy of voices may affect not only a spectrum, in a subband, that exhibits a higher SNR than the first threshold level but also other sepectra in the subband. The effects of voices spread over a plurality of subbands, as a fundamental pitch or harmonic overtones. Thus, even if there is only one spectrum, in a subband of a per-frame input signal, that exhibits a higher SNR than the first threshold level, the energy components of voices may be involved in other subbands of this input signal. However, the time-domain averaging unit 36 excludes this subband or the per-frame input signal involving this subband from the subband-energy derivation, thus not updating the subband energy at the frame of this input signal. In this way, the time-domain averaging unit 36 can eliminate the effects of voices to the subband energy.

The speech determination unit 38 may be installed with a second threshold level, different from (or unequal to) the first threshold level, to be used for determining whether to include average energy in the averaging in the time domain (in the subband acquisition). In this case, the speech determination unit 38 outputs information on a spectrum exhibiting a higher SNR than the second threshold level to the frequency averaging unit 34. Then, the frequency averaging unit 34 does not derive the average energy of a subband involving a spectrum that exhibits a higher SNR than the second threshold level or of all subbands of a per-frame input signal that involves a spectrum that exhibits a higher energy ratio than the second threshold level. Accordingly, the time-domain averaging unit 36 does not include the average energy discussed above in the averaging in the time domain (in the subband energy acquisition).

Accordingly, using the second threshold level, the speech determination unit 38 can determine whether to include average energy in the averaging in the time domain at the time-domain averaging unit 36, separately from the speech segment determination process.

The second threshold level can be set higher or lower than the first threshold level for the processes of determination of speech segments and inclusion of average energy in the averaging in the time domain, performed separately from each other for each subband.

Described first is that the second threshold level is set higher than the first threshold level. The speech determination unit 38 determines that there is no speech segment in a subband if the subband does not involve a spectrum exhibiting a higher energy ratio than the first threshold level. In this case, the speech determination unit 38 determines to include the average energy in that subband in the averaging in the time domain at the time-domain averaging unit 36. On the contrary, the speech determination unit 38 determines that there is a speech segment in a subband if the subband involves a spectrum exhibiting an energy ratio higher than the first threshold level but equal to or lower than the second threshold level. In this case, the speech determination unit 38 also determines to include the average energy in that subband in the averaging in the time domain at the time-domain averaging unit 36. However, the speech determination unit 38 determines that there is a speech segment in a subband if the subband involves a spectrum exhibiting a higher energy ratio than the second threshold level. In this case, the speech determination unit 38 determines not to include the average energy in that subband in the averaging in the time domain at the time-domain averaging unit 36.

Described next is that the second threshold level is set lower than the first threshold level. The speech determination unit 38 determines that there is no speech segment in a subband if the subband does not involve a spectrum exhibiting a higher energy ratio than the second threshold level. In this case, the speech determination unit 38 determines to include the average energy in that subband in the averaging in the time domain at the time-domain averaging unit 36. Moreover, the speech determination unit 38 determines that there is no speech segment in a subband if the subband involves a spectrum exhibiting an energy ratio higher than the second threshold level but equal to or lower than the first threshold level. In this case, the speech determination unit 38 determines not to include the average energy in that subband in the averaging in the time domain direction at the time-domain averaging unit 36. Furthermore, the speech determination unit 38 determines that there is a speech segment in a subband if the subband involves a spectrum exhibiting a higher energy ratio than the first threshold level. In this case, the speech determination unit 38 also determines not to include the average energy in that subband in the averaging in the time domain at the time-domain averaging unit 36.

As described above, using the second threshold level different from the first threshold level, the time-domain averaging unit 36 can derive subband energy more appropriately.

If subband energy is affected by the voice energy of high level, speech determination is inevitably performed based on subband energy higher than an actual noise level, resulting in a bad result. In order to avoid such a problem, the speech segment determiner 11a controls the effects of voice energy to subband energy after speech segment determination to accurately detect formants while preserving correct subband energy.

As described above in detail, the speech segment determiner 11a employing the speech segment determination technique I is provided with: the frame extraction unit 31 that extracts a signal portion for each frame having a specific duration from an input signal, to generate per-frame input signals; the spectrum generation unit 32 that performs frequency analysis of the per-frame input signals to convert the per-frame input signals in the time domain into per-frame input signals in the frequency domain, thereby generating a spectral pattern; the subband division unit 33 that divides the spectral pattern into a plurality of subbands each having a specific bandwidth; the frequency averaging unit 34 that acquires average energy for each subband; the storage unit 35 that stores the average energy per subband for a specific number of frames; the time-domain averaging unit 36 that derives subband energy that is the average of the average energy over a plurality of frames in the time domain; the peak detection unit 37 that derives an energy ratio of the energy in each spectrum in the spectral pattern to the subband energy in a subband in which the spectrum is involved; and the speech determination unit 38 that determines whether a per-frame input signal of a target frame is a speech segment, based on the energy ratio.

The speech determination unit 38 determines that a per-frame input signal of a target frame is a speech segment when the number of spectra of the per-frame input signal, having the energy ratio that exceeds the first threshold level, is equal to or larger than a predetermined number, for example.

Next, the speech segment determination technique II will be explained. The speech segment determination technique II focuses on the characteristics of a consonant that exhibits a spectral pattern having a tendency of rise to the right, to detect a speech segment. In detail, according to the speech segment determination technique II, a spectral pattern of a consonant is detected in a range of an intermediate to a high frequency band, and a frequency distribution of the consonant embedded in noises but with less effects of the noises is extracted to detect a speech segment.

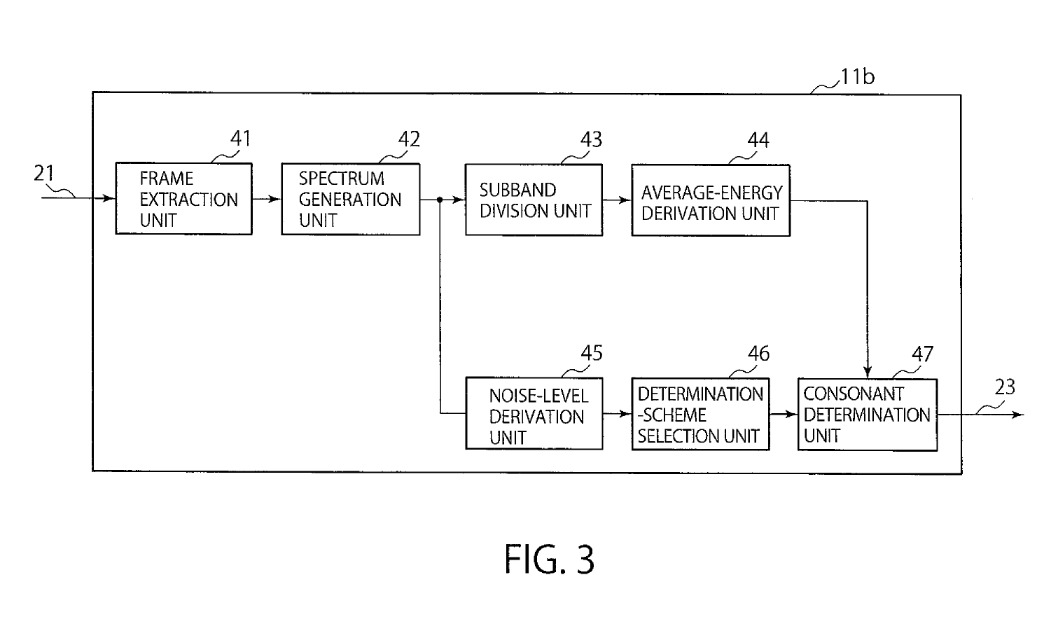

FIG. 3 is a block diagram schematically showing the configuration of a speech segment determiner 11b employing the speech segment determination technique II.

The speech segment determiner 11b is provided with a frame extraction unit 41, a spectrum generation unit 42, a subband division unit 43, an average-energy derivation unit 44, a noise-level derivation unit 45, a determination-scheme selection unit 46, and a consonant determination unit 47.

In FIG. 3, the sound pick-up signal 21 output from the AD converter 113 (FIG. 8) is input to the frame extraction unit 41. The frame extraction unit 41 extracts a signal portion for each frame having a specific duration corresponding to a specific number of samples from the input digital signal, to generate per-frame input signals. The frame extraction unit 41 sends the generated per-frame input signals to the spectrum generation unit 42 one after another.

The spectrum generation unit 42 performs frequency analysis of the per-frame input signals to convert the per-frame input signals in the time domain into per-frame input signals in the frequency domain, thereby generating a spectral pattern. The technique of frequency conversion of per-frame signals in the time domain into the frequency domain is not limited to any particular one. Nevertheless, the frequency conversion requires high frequency resolution enough for recognizing speech spectra. Therefore, the technique of frequency conversion in this embodiment may be FFT (Fast Fourier Transform), DCT (Discrete Cosine Transform), etc. that exhibit relatively high frequency resolution.

A spectral pattern generated by the spectrum generation unit 42 is sent to the subband division unit 43 and the noise-level derivation unit 45.

The subband division unit 43 divides each spectrum of the spectral pattern into a plurality of subbands each having a specific bandwidth. In FIG. 3, each spectrum in the range from 800 Hz to 3.5 kHz is separated into subbands each having a bandwidth in the range from 100 Hz to 300 Hz, for example. The spectral pattern having spectra divided as described above is sent to the average-energy derivation unit 44.

The average-energy derivation unit 44 derives subband average energy that is the average energy in each of the subbands adjacent one another divided by the subband division unit 43. The subband average energy in each of the subbands is sent to the consonant determination unit 47.

The consonant determination unit 47 compares the subband average energy between a first subband and a second subband that comes next to the first subband and that is a higher frequency band than the first subband, in each of consecutive pairs of first and second subbands. Each subband that is a higher frequency band in each former pair is the subband that is a lower frequency band in each latter pair that comes next to the each former subband. Then, the consonant determination unit 47 determines that a per-frame input signal having a pair of first and second subbands includes a consonant segment if the second subband has higher subband average energy than the first subband. These comparison and determination by the consonant determination unit 47 are referred as determination criteria, hereinafter.

In detail, the subband division unit 43 divides each spectrum of the spectral pattern into a subband 0, a subband 1, a subband 2, a subband 3, . . . , a subband n−2, a subband n−1, and a subband n (n being a natural number) from the lowest to the highest frequency band of each spectrum. The average-energy derivation unit 44 derives subband average energy in each of the divided subbands. The consonant determination unit 47 compares the subband average energy between the subbands 0 and 1 in a pair, between the subbands 1 and 2 in a pair, between the subbands 2 and 3 in a pair, . . . , between the subbands n−2 and n−1 in a pair, and between the subbands n−1 and n in a pair. Then, the consonant determination unit 47 determines that a per-frame input signal having a pair of a first subband and a second subband that comes next the first subband includes a consonant segment if the second subband (that is a higher frequency band than the first band) has higher subband average energy than the first subband. The determination is performed for the succeeding pairs.

In general, a consonant exhibits a spectral pattern that has a tendency of rise to the right. With the attention being paid to this tendency, the consonant-segment detection apparatus 47 derives subband average energy for each of subbands in a spectral pattern and compares the subband average energy between consecutive two subbands to detect the tendency of spectral pattern to rise to the right that is a feature of a consonant. Therefore, the speech segment determiner 11b can accurately detect a consonant segment included in an input signal.

In order to determine consonant segments, the consonant determination unit 47 is implemented with a first determination scheme and a second determination scheme.

In the first determination scheme: the number of subband pairs is counted that are extracted according to the determination criteria described above; and the counted number is compared with a predetermined first threshold value, to determine a per-frame input signal having the subband pairs includes a consonant segment if the counted number is equal to or larger than the first threshold value.

Different from the first determination scheme, if subband pairs extracted according to the determination criteria described above are consecutive pairs, the second determination scheme is performed as follows: the number of the consecutive subband pairs is counted with weighting by a weighting coefficient larger than 1; and the weighted counted number is compared with a predetermined second threshold value, to determine a per-frame input signal having the consecutive subband pairs includes a consonant segment if the weighted counted number is equal to or larger than the second threshold value.

The first and second determination schemes are selectively used depending on a noise level, as explained below.

When a noise level is relatively low, a consonant segment exhibits a spectral pattern having a clear tendency of rise to the right. In this case, the consonant determination unit 47 uses the first determination scheme to accurately detect a consonant segment based on the number of subband pairs detected according to the determination criteria described above.

On the other hand, when a noise level is relatively high, a consonant segment exhibits a spectral pattern with no clear tendency of rise to the right, due to being embedded in noises. Therefore, the consonant determination unit 47 cannot accurately detect a consonant segment based on the number of subband pairs detected randomly among the subband pairs according to the determination criteria, with the first determination scheme. In this case, the consonant determination unit 47 uses the second determination scheme to accurately detect a consonant segment based on the number of subband pairs that are consecutive pairs detected (not randomly detected among the subband pairs) according to the determination criteria, with weighting to the number of subband pairs by a weighting coefficient or a multiplier larger than 1.

In order to select the first or the second determination scheme, the noise-level derivation unit 45 derives a noise level of a per-frame input signal. In detail, the noise-level derivation unit 45 obtains an average value of energy in all frequency bands in the spectral pattern over a specific period, as a noise level, based on a signal from the spectrum generation unit 42. It is also preferable for the noise-level derivation unit 45 to derive a noise level by averaging subband average energy, in the frequency domain, in a particular frequency band in the spectral pattern over a specific period based on the subband average energy derived by the average-energy derivation unit 44. Moreover, the noise-level derivation unit 45 may derive a noise level for each per-frame input signal.

The noise level derived by the noise-level derivation unit 45 is supplied to the determination-scheme selection unit 46. The determination-scheme selection unit 46 compares the noise level and a fourth threshold value that is a value in the range from −50 dB to −40 dB, for example. If the noise level is smaller than the fourth threshold value, the determination-scheme selection unit 46 selects the first determination scheme for the consonant determination unit 47, that can accurately detect a consonant segment when a noise level is relatively low. On the other hand, if the noise level is equal to or larger than the fourth threshold value, the determination-scheme selection unit 46 selects the second determination scheme for the consonant determination unit 47, that can accurately detect a consonant segment even when a noise level is relatively high.

Accordingly, with the selection between the first and second determination schemes of the consonant determination unit 47 according to the noise level, the speech segment determiner 11b can accurately detect a consonant segment.

In addition to the first and second determination schemes, the consonant determination unit 47 may be implemented with a third determination scheme which will be described below.

When a noise level is relatively high, the tendency of a spectral pattern of a consonant segment to rise to the right may be embedded in noises. Furthermore, suppose that a spectral pattern has several separated portions each having energy with steep fall and rise with no tendency of rise to the right. Such a spectral pattern cannot be determined as a consonant segment by the second determination scheme with weighting to a continuous rising portion of the spectral pattern (to the number of consecutive subband pairs detected according to the determination criteria, as described above).

Accordingly, the third determination scheme is used when the second determination scheme fails in consonant determination (if the counted weighted number of the consecutive subband pairs having higher average subband energy is smaller than the second threshold value).

In detail, in the third determination scheme, the maximum average subband energy is compared between a first group of at least two consecutive subbands and a second group of at least two consecutive subbands (the second group being of higher frequency than the first group), each group having been detected in the same way as the second determination scheme. The comparison between two first and second groups each of at least two consecutive subbands is performed from the lowest to the highest frequency band in a spectral pattern. Then, the number of groups each having higher subband average energy in the comparison is counted with weighting by a weighting coefficient larger than 1 and the weighted counted number is compared with a predetermined third threshold value, to determine a per-frame input signal having the subband groups includes a consonant segment if the weighted counted number is equal to or larger than the third threshold value.

Accordingly, by way of the third determination scheme with the comparison of subband average energy over a wide range of frequency band, the tendency of rise to the right can be converted into a numerical value by counting the number of subband groups in the entire spectral pattern. Therefore, the speech segment determiner 11b can accurately detect a consonant segment based on the counted number.

As described above, the determination-scheme selection unit 46 selects the third determination scheme when the second determination scheme fails in consonant determination. In detail, even when the second determination scheme determines no consonant segment, there is a possibility of failure to detect consonant segments. Accordingly, when the second determination scheme determines no consonant segment, the consonant determination unit 47 uses the third determination scheme that is more robust against noises than the second determination scheme to try to detect consonant segments. Therefore, with the configuration described above, the speech segment determiner 11b can detect consonant segments more accurately.

As described above in detail, the speech segment determiner 11b employing the speech segment determination technique II is provided with: the frame extraction unit 41 that extracts a signal portion for each frame having a specific duration from an input signal, to generate per-frame input signals; the spectrum generation unit 42 that performs frequency analysis of the per-frame input signals to convert the per-frame input signals in the time domain into per-frame input signals in the frequency domain, thereby generating a spectral pattern; the subband division unit 43 that divides the spectral pattern into a plurality of subbands each having a specific bandwidth; the average-energy derivation unit 44 that derives subband average energy that is the average energy in each of the subbands adjacent one another; the noise-level derivation unit 45 that derives a noise level of each per-frame input signal; the determination-scheme selection unit 46 that compares the noise level and a predetermined threshold value to select a determination scheme; and the consonant determination unit 47 that compares the subband average energy between subbands according to the selected determination scheme to detect a consonant segment.

The consonant determination unit 47 compares the subband average energy between a first subband and a second subband that comes next to the first subband and that is a higher frequency band than the first subband, in each of consecutive pairs of first and second subbands. Each subband that is a higher frequency band in each former pair is the subband that is a lower frequency band in each latter pair that comes next to the each former subband. Then, the consonant determination unit 47 determines that a per-frame input signal having a pair of first and second subbands includes a consonant segment if the second subband has higher subband average energy than the first subband. It is also preferable for the consonant determination unit 47 to determine that a per-frame input signal having subband pairs includes a consonant segment if the number of the subband pairs, in each of which the second subband has higher subband average energy than the first subband, is larger than a predetermined value.

As described above in detail, according to the speech segment determiner 11b, consonant segments can be detected accurately in an environment at a relatively high noise level.

When the speech segment determination technique I or II described above is applied to the noise reduction apparatus 1 in this embodiment, a parameter can be set to each equipment provided with the noise reduction apparatus 1. In detail, when the speech segment determination technique I or II is applied to equipment provided with the noise reduction apparatus 1 that requires higher accuracy for the speech segment determination, higher or larger threshold levels or values (in the technique I or II) can be set as a parameter for the speech segment determination.

Returning to FIG. 1, the voice direction detector 12 of the noise reduction apparatus 1 detects a voice incoming direction that indicates a direction from which a voice sound travels, based on the sound pick-up signals 21 and 22 and outputs voice incoming-direction information 24 to the noise reduction-amount adjuster 16. The voice incoming direction corresponds to the angle of incidence of a voice sound with respect to the main microphone 111 (FIG. 8).

There are several techniques for voice direction detection. One technique is to detect a voice incoming direction based on a phase difference between the sound pick-up signals 21 and 22. Another technique is to detect a voice incoming direction based on the difference or ratio between the magnitudes of a sound (the sound pick-up signal 21) picked up by the main microphone 111 and a sound (the sound pick-up signal 22) picked up by the sub-microphone 112. The difference and the ratio between the magnitudes of sounds are referred to as a power difference and a power ratio, respectively. Both factors are referred to as power information, hereinafter.

Whatever the technique is used, the voice direction detector 12 detects a voice incoming direction only when the speech segment determiner 11 determines that a sound picked up by the main microphone 111 is a speech segment, or detects a speech segment. In other words, the voice direction detector 12 detects a voice incoming direction in the duration of a speech segment, or while a voice sound is arriving, whereas does not detect a voice incoming direction in any duration except for a speech segment.

The main microphone 111 and the sub-microphone 112 shown in FIG. 8 may be provided on both sides of equipment having the noise reduction apparatus 1 installed therein. In detail, the main microphone 111 may be provided on the front face of the equipment on which a voice sound can be easily picked up whereas the sub-microphone 112 may be provided on the rear face of the equipment on which a voice sound can not be easily picked up. This microphone arrangement is particularly useful when the equipment having the noise reduction apparatus 1 installed therein is mobile equipment (a wireless communication apparatus) such as a transceiver, compact equipment such as a speaker microphone (an audio input apparatus) connected to a wireless communication apparatus, etc. With this microphone arrangement, the main microphone 111 can mainly pick up a voice component whereas the sub-microphone 112 can mainly pick up a noise component.

The wireless communication apparatus and the audio input apparatus described above usually have a size a little bit smaller than a user's clenched fist. Therefore, it is quite conceivable that the difference between a distance from a sound source to the main microphone 111 and a distance from the sound source to the sub-microphone 112 is in the range from about 5 cm to 10 cm, although depending on the apparatus, microphone arrangement, etc. When a voice spatial travel speed is set to 34,000 cm/s, the distance by which a voice sound travels is 4.25 (=34,000/8,000) cm during one sampling period at a sampling frequency of 8 kHz. If the distance between the main microphone 111 and the sub-microphone 112 is 5 cm, it is not enough to predict a voice incoming direction at a sampling frequency of 8 kHz.

In this case, when the sampling frequency is set to 24 kHz three times as high as 8 kHz, the distance by which a voice sound travels is about 1.42 (≈34,000/24,000) cm during one sampling period. Therefore, three or four phase difference points can be found in the distance of 5 cm. Accordingly, for the detection of a voice incoming direction based on the phase difference between the sound pick-up signals 21 and 22, it is preferable to set the sampling frequency to 24 kHz or higher for these pick-up signals to be input to the voice direction detector 12.

In the noise reduction apparatus 1 shown in FIG. 8, suppose that the sampling frequency for the sound pick-up signals 21 and 22 output from the A/D converters 113 and 114, respectively, is in the range from 8 kHz to 12 kHz. In this case, a sampling frequency converter may be provided between the A/D converters 113 and 114, and the voice direction detector 12, to convert the sampling frequency for the sound pick-up signals 21 and 22 to be supplied to the voice direction detector 12 into 24 kHz or higher.

Conversely, it is supposed in the noise reduction apparatus 1 shown in FIG. 8 that the sampling frequency for the sound pick-up signals 21 and 22 output from the A/D converters 113 and 114 is 24 kHz or higher. In this case, it is a feasible option to provide a sampling frequency converter between the A/D converter 113 and the speech segment determiner 11, and another sampling frequency converter between the A/D converters 113 and 114, and the noise reduction-amount processor 13, to convert the sampling frequency for the sound pick-up signals 21 and 22 into a frequency in the range from 8 kHz to 12 kHz.

The detection of a voice incoming direction based on the phase difference between the sound pick-up signals 21 and 22 mentioned above will be explained in detail.

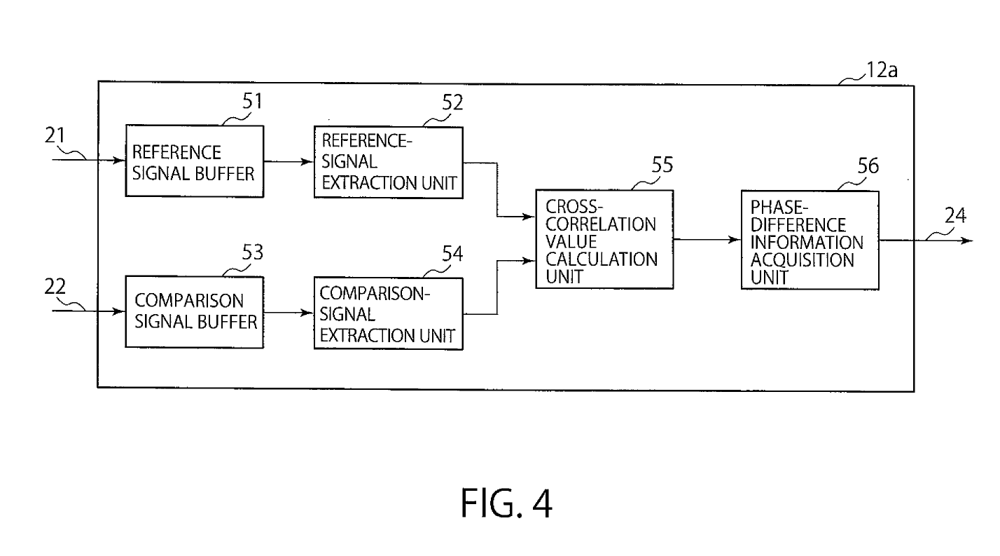

FIG. 4 is a block diagram showing an exemplary configuration of a voice direction detector 12a installed in the noise reduction apparatus 1 in this embodiment, for detection of a voice incoming direction based on the phase difference between the sound pick-up signals 21 and 22.

The voice direction detector 12a shown in FIG. 4 is provided with a reference signal buffer 51, a reference-signal extraction unit 52, a comparison signal buffer 53, a comparison-signal extraction unit 54, a cross-correlation value calculation unit 55, and a phase-difference information acquisition unit 56.

The reference signal buffer 51 temporarily stores a sound pick-up signal 21 output from the A/D converter 113 (FIG. 8), as a reference signal. The comparison signal buffer 53 temporarily stores a sound pick-up signal 22 output from the A/D converter 114 (FIG. 8), as a comparison signal. The reference and comparison signals are used for the calculation at the cross-correlation value calculation unit 55, which will be described later.

In general, a sound-pick up signal obtained at a given moment carries various sounds that surround a voice source, in addition to a voice sound. Therefore, there is a difference in phase, magnitude, etc. detected through the main microphone 111 and the sub-microphone 112 in FIG. 8 due to the difference in travel path to the microphones 111 and 112. However, if there is only one sound source, it can be said that voice sounds picked up by the main microphone 111 and the sub-microphone 112 have a specific relationship with each other concerning the phase, magnitude, etc., thus having a high correlation with each other.

In this embodiment (FIG. 1), a voice incoming direction is detected by the voice direction detector 12 only when the speech segment determiner 11 detects a speech segment. It is thus quite conceivable that voice sounds picked up by the main microphone 111 and the sub-microphone 112 have a high correlation with each other when a voice incoming direction is detected by the voice direction detector 16. Therefore, by measuring the correlation between sounds picked up by the main microphone 111 and the sub-microphone 112 only when the speech segment determiner 11 detects a speech segment, the phase difference of sounds between the two microphones can be obtained to predict a voice incoming direction from a sound source. The phase difference of sounds between the main microphone 111 and sub-microphone 112 can be calculated using the cross correlation function or by the least square method.

The cross correlation function for two signal waveforms x1(t) and x2(t) is expressed by the following equation (5).

$${ϕ}_{1 , 2} ( τ ) = ( \frac{1}{N} ) n = {\sum }_{N = 0}^{N - 1} {x}_{1} ( t ) {x}_{2} ( t + τ ) \qquad ( 5 )$$

When the cross correlation function is used, in FIG. 4, the reference-signal extraction unit 52 extracts a signal waveform x1(t) carried by a sound pick-up signal (reference signal) 21 and sets the signal waveform x1(t) as a reference waveform. On the other hand, the comparison-signal extraction unit 54 extracts a signal waveform x2(t) carried by a sound pick-up signal (comparison signal) 22 and shifts the signal waveform x2(t) in relation to the signal waveform x1(t).

The cross-correlation value calculation unit 55 performs convolution (a product-sum operation) to the signal waveforms x1(t) and x2(t) to find signal points of the sound pick-up signals 21 and 22 having a high correlation. In this operation, the signal waveform x2(t) is shifted forward and backward (delayed and advanced) in relation to the signal waveform x1(t) in accordance with the maximum phase difference calculated based on the sampling frequency for the sound pick-up signal 22 and the spatial distance between the main microphone 111 and the sub-microphone 112, to calculate a convolution value. It is determined that signal points of the sound pick-up signals 21 and 22 having the maximum convolution value and the same sign (positive or negative) have the highest correlation.

When the least square method is used instead of convolution, the following equation (6) can be used.

Err(τ)=Σₜ₌₀^{N-1}(x₁(t)−x₂(t+τ))² (6)

When the least square method is used, the reference-signal extraction unit 52 extracts a signal waveform carried by a sound pick-up signal (reference signal) 21 and sets the signal waveform as a reference waveform. On the other hand, the comparison-signal extraction unit 54 extracts a signal waveform carried by a sound pick-up signal (comparison signal) 22 and shifts the signal waveform in relation to the reference signal waveform of the sound pick-up signal 21.

The cross-correlation value calculation unit 55 calculates the sum of squares of differential values between the reference and comparison signal waveforms of the sound pick-up signals 21 and 22, respectively. It is determined that signal points of the sound pick-up signals 21 and 22 having the minimum sum of squares are the portions of the signals 21 and 22 where the both signals have a similar waveform (or overlap each other) at the highest correlation. It is preferable for the least square method to adjust a reference signal and a comparison signal to have the same magnitude. It is therefore preferable to normalize the reference and comparison signals using either signal as a reference.

Then, the cross-correlation value calculation unit 55 outputs information on correlation between the reference and comparison signals, obtained by the calculation described above, to the phase-difference information acquisition unit 56. Suppose that there are two signal waveforms (a signal waveform carried by the sound pick-up signal 21 and a signal waveform carried by the sound pick-up signal 22) that are determined by the cross-correlation value calculation unit 55 as having a high correlation with each other. In this case, it is highly likely that the two signals waveforms are signal waveforms of voice sounds generated by a single sound source. The phase-difference information acquisition unit 56 acquires a phase difference between the two signal waveforms determined as having a high correlation with each other to obtain a phase difference between a voice component picked up by the main microphone 111 and a voice component picked up by the sub-microphone 112.

There are two cases concerning the phase difference acquired by the phase-difference information acquisition unit 56, that are phase advance and phase delay.

In the case of phase advance, the phase of a voice component included in a sound picked up by the main microphone 111 (the phase of a voice component carried by the sound pick-up signal 21) is more advanced than the phase of a voice component included in a sound picked up by the sub-microphone 112 (the phase of a voice component carried by the sound pick-up signal 22). In this case, it is presumed that a sound source is located closer to the main microphone 111 than to the sub-microphone 112, or a user speaks into the main microphone 111.

In the case of phase delay, the phase of a voice component included in a sound picked up by the main microphone 111 is more delayed than the phase of a voice component included in a sound picked up by the sub-microphone 112 (the phase of a voice component carried by the sound pick-up signal 21 is more delayed than the phase of a voice component carried by the sound pick-up signal 22). In this case, it is presumed that a sound source is located closer to the sub-microphone 112 than to the main microphone 111, or a user speaks into the sub-microphone 112.

Moreover, there is a case in which the phase difference between a phase of a voice component included in a sound picked up by the main microphone 111 and a phase of a voice component included in a sound picked up by the sub-microphone 112 (the phase difference between a phase of a voice component carried by the sound pick-up signal 21 and a phase of a voice component carried by the sound pick-up signal 22) falls in a specific range (−T<phase difference<T), or the absolute value of the phase difference is smaller than a specific value T. In this case, it is presumed that a sound source is located in a center area between the main microphone 111 and the sub-microphone 112.

Based on the presumption discussed above, the phase-difference information acquisition unit 56 outputs the acquired phase difference information to the noise reduction-amount adjuster 16 (FIG. 1), as voice incoming-direction information 24.

As described above, the voice direction detector 12a calculates a phase difference based on a cross-correlation value obtained by using a first group of sampled sound pick-up signals (references signals) 21 and a second group of sampled sound pick-up signals (comparison signals) 22. The first group may be used as comparison signals and the second group may be used as comparison signals.

In FIG. 1, the voice direction detector 12 detects a voice incoming direction when the speech segment determiner 11 determines that a sound picked up by the main microphone 111 is a speech segment (voice component) based on the sound pick-up signal 21 input thereto. As discussed above, it is presumed that a voice component picked up by the main microphone 111 and a voice component picked up by the sub-microphone 112 have a high correlation if both voice components are included in a sound generated by a single sound source. Therefore, even if this sound includes a noise component, the voice direction detector 12 can accurately calculate a phase difference between voice components picked up by the main microphone 111 and the sub-microphone 12 when the voice direction detector 12a (FIG. 4) is used as the voice direction detector 12.

The detection of a voice incoming direction based on the power information on the sound pick-up signals 21 and 22 mentioned above will be explained next in detail.

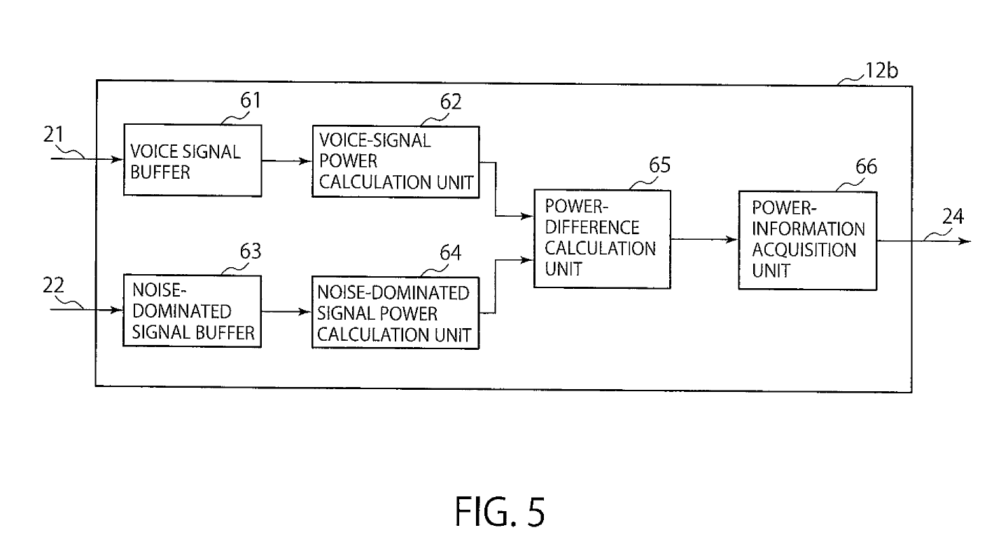

FIG. 5 is a block diagram showing an exemplary configuration of a voice direction detector 12b installed in the noise reduction apparatus 1 in this embodiment, for detection of a voice incoming direction based on the power information on the sound pick-up signals 21 and 22.

The voice direction detector 12b shown in FIG. 5 is provided with a voice signal buffer 61, a voice-signal power calculation unit 62, a noise-dominated signal buffer 63, a noise-dominated signal power calculation unit 64, a power-difference calculation unit 65, and a power-information acquisition unit 66. The voice direction detector 12b obtains power information (power difference in FIG. 5) on the sound pick-up signals 21 and 22 per unit time (for each predetermined duration).

The voice signal buffer 61 temporarily stores a sound pick-up signal 21 supplied from the A/D converter 113 (FIG. 8) in order to store the sound pick-up signal 21 for a predetermined duration. The noise-dominated signal buffer 63 also temporarily stores a sound pick-up signal 22 supplied from the A/D converter 114 (FIG. 8) in order to store the sound pick-up signal 22 for the predetermined duration.

The sound pick-up signal 21 stored by the voice signal buffer 61 for the predetermined duration is supplied to the voice-signal power calculation unit 62 for calculation of a power value for the predetermined duration. The sound pick-up signal 22 stored by the noise-dominated signal buffer 63 for the predetermined duration is supplied to the noise-dominated signal power calculation unit 64 for calculation of a power value for the predetermined duration.

A power value per unit of time (for each predetermined duration) is the magnitude of the sound pick-up signals 21 and 22 per unit of time, for example, the maximum amplitude, an integral value of amplitude of the sound pick-up signals 21 and 22 per unit of time, etc. Any value that indicates the magnitude of the sound pick-up signals 21 and 22 may be used in the voice direction detector 12b.

The power values of the sound pick-up signals 21 and 22 obtained by the voice-signal power calculation unit 62 and the noise-dominated signal power calculation unit 64, respectively, are supplied to the power-difference calculation unit 65. The power-difference calculation unit 65 calculates a power difference between the power values and outputs a calculated power difference to the power-information acquisition unit 66. Based on the output power difference, the power-information acquisition unit 66 acquires power information on the sound pick-up signals 21 and 22.

Concerning the magnitude of the sound pick-up signals 21 and 22, there are two cases for the magnitude of sounds picked up by the main microphone 111 and the sub-microphone 112.

A first case is that the magnitude of a sound picked up by the main microphone 111 is larger than a sound picked up by the sub-microphone 112. This is the case in which a power value of the sound pick-up signal 21 is larger than a power value of the sound pick-up signal 22. In this case, it is presumed that a sound source is located closer to the main microphone 111 than to the sub-microphone 112, or a user speaks into the main microphone 111.

A second case is that the magnitude of a sound picked up by the main microphone 111 is smaller than a sound picked up by the sub-microphone 112 (a power value of the sound pick-up signal 21 is smaller than a power value of the sound pick-up signal 22). This is the case in which a power value of the sound pick-up signal 21 is smaller than a power value of the sound pick-up signal 22. In this case, it is presumed that a sound source is located closer to the sub-microphone 112 than to the main microphone 111, or a user speaks into the sub-microphone 112.

Moreover, there is a case in which the power difference between a sound picked up by the main microphone 111 and a sound picked up by the sub-microphone 112 (the power difference between a power value of the sound pick-up signal 21 and a power value of the sound pick-up signal 22) falls in a specific range (−P<power difference<P), or the absolute value of the power difference is smaller than a specific value P. In this case, it is presumed that a sound source is located in a center area between the main microphone 111 and the sub-microphone 112.

Based on the presumption discussed above, the power-information acquisition unit 66 outputs the acquired power information (information on power difference) to the noise reduction-amount adjuster 16 (FIG. 1), as voice incoming-direction information 24.

As described above, the voice direction detector 12 detects a voice incoming direction based on the phase difference between or power information on the sound pick-up signals 21 and 22, in this embodiment. The method of detecting a voice incoming direction may be performed based on the phase difference only or the power information only, or a combination of these factors. The combination of the phase difference and power information is useful for mobile equipment (a wireless communication apparatus) such as a transceiver, compact equipment such as a speaker microphone (an audio input apparatus) attached to a wireless communication apparatus, etc. This is because, in such mobile equipment and compact equipment, it could happen that a microphone is covered with a user's hand or clothes, depending on how a user holds a mobile equipment or compact equipment. For such a mobile equipment and compact equipment, the voice direction detector 16 can more accurately detect a voice incoming direction based on both of the phase difference between and the power information on the sound pick-up signals 21 and 22.

The noise reduction processor 13 shown in FIG. 1 performs a noise reduction process to reduce noise components carried by the pick-up signal 21 by using the sound pick-up signal 22. In the noise reduction process, the noise reduction processor 13 adjusts a noise reduction amount in accordance with a voice incoming direction detected by the voice direction detector 12.

As already described, the noise reduction processor 13 has the adaptive filter 14, the adaptive coefficient adjuster 15, the noise reduction-amount adjuster 16, and the adders 17 and 18.

The adaptive filter 14 generates a noise-presumed signal 25 that corresponds to a noise component carried by the sound pick-up signal 21 by using the sound pick-up signal 22 that mainly carries a noise component. In detail, the adaptive filter 14 generates a pseudo-noise component that is highly likely carried by the sound pick-up signal 21 (a voice signal) if it is a real noise component, as the noise-presumed signal 25. The noise-presumed signal 25 in this embodiment is a phase-reversed signal with respect to the sound pick-up signal 21.

The adder 17 adds the sound pick-up signal 21 and the phase-reversed noise-presumed signal 25 to generate a feedback signal (an error signal) 26 and supplies the signal 26 to the adaptive coefficient adjuster 15. The adder 17 may subtract the noise-presumed signal 25 from the sound pick-up signal 21 to generate the feedback signal 26. In this case, instead of the adder 17, a subtracter is used, as an arithmetic unit, to subtract a noise-presumed signal 25 that is not phase-revered from the sound pick-up signal 21 to generate the feedback signal 26.

The adaptive coefficient adjuster 15 adjusts the adaptive coefficients of the adaptive filter 14 based on the feedback signal 26 obtained by an arithmetic operation between the sound pick-up signal 21 and the noise-presumed signal 25. The adaptive coefficient adjuster 15 adjusts the adaptive coefficients of the adaptive filter 14 in accordance with the speech segment information 23 supplied from the speech segment determiner 11. In detail, the adaptive coefficient adjuster 15 adjusts the adaptive coefficients to have a smaller adaptive error when the speech segment information 23 indicates a noise segment (a non-speech segment). On the other hand, the adaptive coefficient adjuster 15 makes no adjustments or a fine adjustment only to the adaptive coefficients when the speech segment information 23 indicates a speech segment.

The noise reduction-amount adjuster 16 adjusts the noise-presumed signal 25 in accordance with the voice incoming-direction information 24 that indicates a voice incoming direction and supplied from the voice direction detector 12 and outputs an adjusted noise-presumed signal 28 to the adder 18.

There are various ways for the noise reduction-amount adjuster 16 to adjust the noise-presumed signal 25, as described below.

For example, when it is determined by the voice direction detector 12 that the phase difference between a phase of the sound pick-up signal 21 (a voice component included in a sound picked up by the main microphone 111) and a phase of the sound pick-up signal 22 (a voice component included in a sound picked up by the sub-microphone 112) falls in a specific range (−T<phase difference<T), or the absolute value of the phase difference is smaller than a specific value T that can be set freely, the noise reduction-amount adjuster 16 reduces the noise-presumed signal 25 (the first case). Moreover, when it is determined by the voice direction detector 12 that the phase of the sound pick-up signal 21 (a voice component included in a sound picked up by the main microphone 111) is more delayed than the phase of the sound pick-up signal 22 (a voice component included in a sound picked up by the sub-microphone 112), the noise reduction-amount adjuster 16 reduces the noise-presumed signal 25 (the second case).

In this way, the noise reduction-amount adjuster 16 reduces the noise-presumed signal 25 to reduce a noise reduction amount in the noise reduction processor 13. The noise reduction processor 13 may reduce the noise reduction amount when at least either one of the first and second cases described above is established.

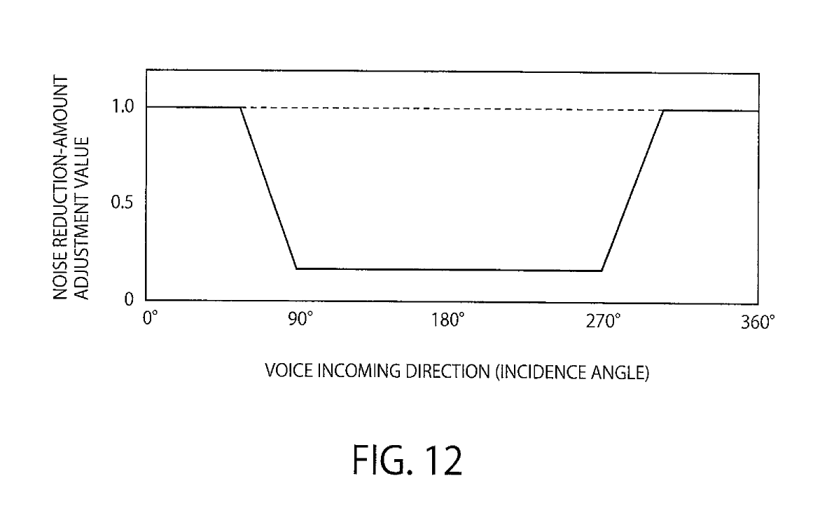

Another way for the noise reduction-amount adjuster 16 to adjust the noise-presumed signal 25 is as follows. The noise reduction-amount adjuster 16 stores noise reduction-amount adjustment values with respect to the location of a voice source, as shown in FIG. 12. Then, the noise reduction-amount adjuster 16 looks up the noise reduction-amount adjustment values in accordance with a voice incoming direction (the location of a voice source) determined by the voice direction detector 12 to decide a noise reduction-amount adjustment value to be multiplied to the noise-presumed signal 25.

And the noise reduction-amount adjuster 16 multiplies the noise reduction-amount adjustment value and the noise-presumed signal 25 to adjust the magnitude of the noise-presumed signal 25 to reduce a noise reduction amount in the noise reduction processor 13. The noise reduction-amount adjustment value may be in the range from 0 to 1. When the noise reduction-amount adjustment value is 1, the noise reduction-amount adjuster 16 outputs the noise-presumed signal 25 with no adjustment, as the adjusted noise-presumed signal 28 (the noise-presumed signal 25 being equal to the adjusted noise-presumed signal 28). When the noise reduction-amount adjustment value is 0, the noise reduction-amount adjuster 16 outputs no noise-presumed signal (no noise reduction process performed).

Furthermore, for example, when it is determined by the voice direction detector 12 that the power difference between the magnitude of the sound pick-up signal 21 (a sound picked up by the main microphone 111) and the magnitude of the sound pick-up signal 22 (a sound picked up by the sub-microphone 112) falls in a specific range (−P<power difference<P), or the absolute value of the power difference is smaller than a specific value P that can be set freely, the noise reduction-amount adjuster 16 reduces the noise-presumed signal 25 (the first case). Moreover, when it is determined by the voice direction detector 12 that the magnitude of the sound pick-up signal 21 (a sound picked up by the main microphone 111) is smaller than the magnitude of the sound pick-up signal 22 (a sound picked up by the sub-microphone 112), the noise reduction-amount adjuster 16 reduces the noise-presumed signal 25 (the second case).

In this way, the noise reduction-amount adjuster 16 reduces the noise-presumed signal 25 to reduce a noise reduction amount in the noise reduction processor 13. The noise reduction processor 13 may reduce the noise reduction amount when at least either one of the first and second cases described above is established.

Using the adjusted noise-presumed signal 28 from the noise reduction-amount adjuster 16, the adder 18 reduces a noise component carried by the sound pick-up signal 21. In detail, the adder 18 adds the sound pick-up signal 21 and the phase-reversed and adjusted noise-presumed signal 28 to generate a noise-reduced signal and outputs the generated signal as the output signal 29. The adder 18 may subtract the adjusted noise-presumed signal 28 from the sound pick-up signal 21 to generate a noise-reduced output signal 29. In this case, instead of the adder 18, a subtracter is used to subtract an adjusted noise-presumed signal 28 that is not phase-revered from the sound pick-up signal 21 to generate a noise-reduced output signal 29.

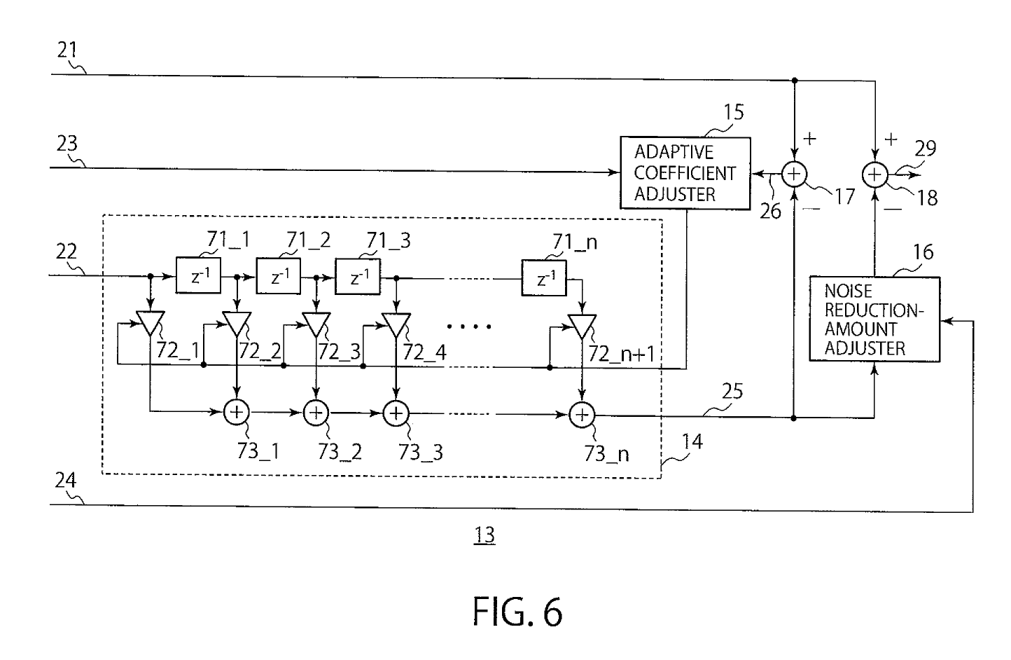

FIG. 6 is a block diagram showing an exemplary configuration of the noise reduction processor 13 installed in the noise reduction apparatus 1 in this embodiment. The noise reduction processor 13 shown in FIG. 6 has an FIR (Finite Impulse Response) filter as the adaptive filter 14, in addition to the adaptive coefficient adjuster 15, the noise reduction-amount adjuster 16 and the adders 17 and 18 which are equivalent to those described above.

The FIR adaptive filter 14 shown in FIG. 6 is provided with delay elements 71-1 to 71-n, multipliers 72-1 to 72-n+1, and adders 73-1 to 73-n, for processing the sound pick-up signal 21 to generate a noise-presumed signal 25.

The adaptive coefficient adjuster 15 adjusts the coefficients of the multipliers 72-1 to 72-n+1. In detail, the adaptive coefficient adjuster 15 adjusts the coefficients of the adaptive filter 14 to minimize the difference (the feedback signal 26) between the noise-presumed signal 25 and the sound pick-up signal 21 when the speech segment information 23 indicates a noise segment (a non-speech segment). The coefficient adjustment is made so that the noise-presumed signal 25 becomes similar or closer to the a noise component carried by the sound pick-up signal 21.

When the speech segment information 23 indicates a speech segment, it means that the sound pick-up signal 21 carries a voice component. In this case, it may happen that the coefficients of the adaptive filter 14 do not converge without being adapted to a noise component due to the effect of the voice component. Therefore, when the speech segment information 23 indicates a speech segment, it is preferable to make no adjustments or a fine adjustment only to the coefficients of the adaptive filter 14 in order to stably update the coefficients.

The speech segment information 23 supplied from the speech segment determiner 11 is used to adjust the learning speed of the adaptive filter adjuster 15 concerning the adaptive coefficients. Moreover, the speech segment information 23 is important information for the adaptive filter 14 to acquire accurate spatial acoustic characteristics (transfer characteristics between the main microphone 111 and sub-microphone 112) in an environment in which the noise reduction apparatus 1 is located.

In the noise reduction process using the adaptive filter 14, when the sound pick-up signal (noise signal) 22 carries a voice component, the adaptive filter 14 generates a noise-presumed signal 25 that carries a phase-reversed component of the voice component. Therefore, there is a problem in that the output signal 29 after the noise reduction process produces an echo or a speech sound level is lowered.

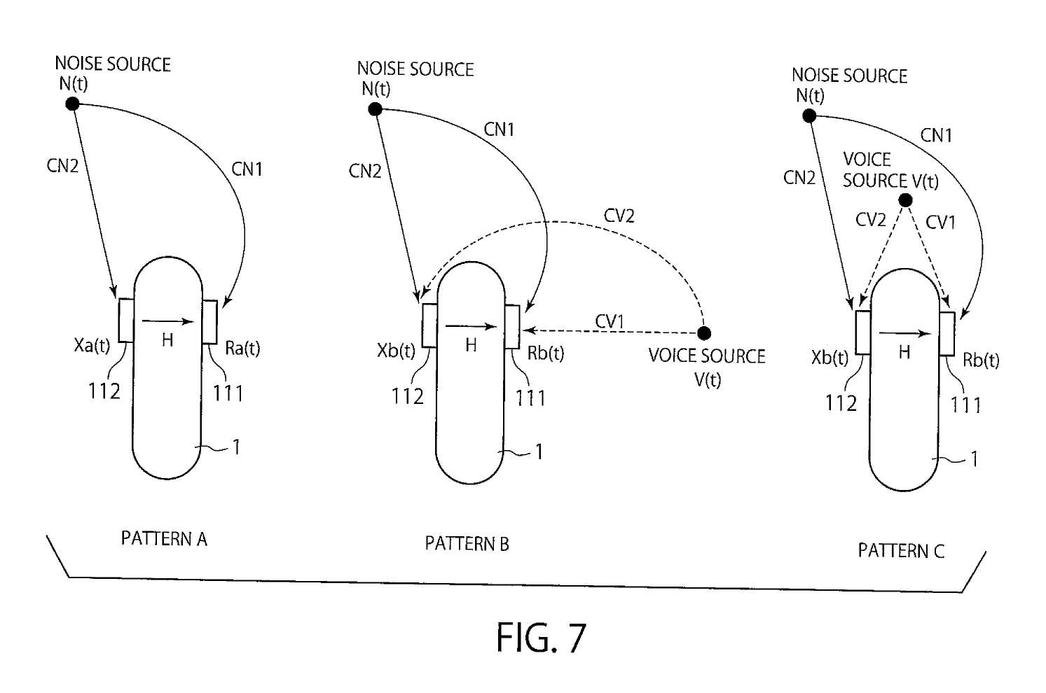

The problem mentioned above is discussed with respect to FIG. 7 that illustrates spatial acoustic characteristics in an environment in which the noise reduction apparatus 1 (FIG. 8) is located.

In FIG. 7, the main microphone 111 and the sub-microphone 112 are arranged so that they face in opposite directions in three patterns A, B and C. The pattern A shows that there is a noise source only. The pattern B shows that there is a noise source at the same position as the pattern A and a voice source is located at an ideal position, that is, the voice source is located at a position at which the voice source faces the main microphone 111. The pattern C shows that there is a noise source at the same position as the pattern A and a voice source is located at a position that exists on an imaginary vertical line extending from around a middle point between the main microphone 111 and the sub-microphone 112. In FIG. 7, a noise source is indicated by a dot. An environment in which there are a plurality of noise sources and various noises from the noise sources are mixed with one another can be treated as a combination of environments each with a noise source indicated by the dot in FIG. 7.

In the following description, several signs represent various factors as follows.

N(t) . . . a noise signal of a noise source

V(t) . . . a voice signal of a voice source

Ra(t), Rb(t) . . . sound pick-up signals obtained from a sound picked up by the main microphone 111, respectively

Xa(t), Xb(t) . . . sound pick-up signals obtained from a sound picked up by the sub-microphone 112, respectively

H . . . transfer characteristics between the main microphone 111 and the sub-microphone 112

CV1, CN1 . . . spatial acoustic characteristics model of voice and noise, respectively, picked up by the main microphone 111

CV2, CN2 . . . spatial acoustic characteristics model of voice and noise, respectively, picked up by the sub-microphone 112

Y(t) . . . an output signal 29 after the noise reduction process

t . . . a variable that represents time

In the pattern A, a sound pick-up signal Ra(t) obtained from a sound picked up by the main microphone 111 and a sound pick-up signal Xa(t) obtained from a sound picked up by the sub-microphone 112 are expressed as follows.

Ra(t)=CN1×N(t) (7)

Xa(t)=CN2×N(t) (8)

The pattern A shows that there is a noise source only. Therefore, the noise-presumed signal 25 and the sound picked-up signal Ra obtained from a sound picked up by the main microphone 111 are equal to each other. Therefore, the following expression (9) is given using the transfer characteristics H.

Ya(t)=Ra(t)−H×Xa(t)=0 (9)

Then, the following expression (10) is given using the expressions (7) to (9).

H=CN1/CN2 (10)

Explained next is the pattern B in which there are a noise source and a voice source. It is assumed that the transfer characteristics H of the noise-presumed signal 25 generated by the adaptive filter 14 is applied only to a noise component. In this case, the spatial acoustic characteristics model CN1 of noises picked up by the main microphone 111 and the spatial acoustic characteristics model CN2 of noises picked up by the sub-microphone 112 are the same as each other in the patterns A and B. Therefore, there is no change in the transfer characteristics H. Thus, the following expressions are given in the pattern B.

Rb(t)=CN1×N(t)+CV1×V(t) (11)

Xb(t)=CN2×N(t)+CV2×V(t) (12)

Then, the following expression (12) is given using the expressions (9) to (12).

Yb(t)=CN1×N(t)+CV1×V(t)−H×(CN2×N(t)+CV2×V(t))=CV1×V(t)−H×CV2×V(t) (13)

When a user (a voice source) speaks in front of the main microphone 111 in the pattern B, the spatial acoustic characteristics CV2 is attenuated much more than the spatial acoustic characteristics CV1 and a delay is added caused by a voice incoming time difference. Therefore, the term “H×CV2×V(t)” in the expression (13) becomes smaller so that the clearness of a voice carried by an output signal Yb after the noise reduction process is maintained.

On the contrary, in the pattern C, there is a user (a voice source) at a position that exists on an imaginary vertical line extending from a middle point between the main microphone 111 and the sub-microphone 112. In this case, the spatial acoustic characteristics CV1 and CV2 are almost equal to each other, and hence the term “H×CV2×V(t)” in the expression (13) becomes larger so that the sound level of a voice component carried by an output signal Yb after the noise reduction process is reduced.

The transfer characteristics H depends on the position of a noise source. It is supposed that a noise source is located at a position that exists on a vertical line extending from a middle point between the main microphone 111 and the sub-microphone 112, like the pattern C. Also it is supposed that the transfer characteristics H is applied to noise components in all incoming directions, with no dominant noise source. In these cases, the transfer characteristics H becomes almost equal to 1 so that an output signal Yb becomes similar to a sound pick-up signal Xb(t) obtained from a sound picked up by the sub-microphone 112. These factors are integrated to reduce a sound level depending on the position of a voice source, and hence the clearness of a voice cannot be maintained.

The reduction in sound level rarely occurs when there is a big difference between the spatial acoustic characteristics CV1 and CV2, and also a big difference between the spatial acoustic characteristics CV2 (or CV1) of a voice source and the spatial acoustic characteristics CN2 (or CN1) of a noise source. On the contrary, the reduction in sound level tend to occur when there is a small difference between the spatial acoustic characteristics CV1 and CV2, and/or a small difference between the spatial acoustic characteristics CV2 (or CV1) of a voice source and the spatial acoustic characteristics CN2 (or CN1) of a noise source. Therefore, if such a small difference is detected, the reduction in sound level can be predicted.

However, it is very difficult to obtain accurate transfer characteristics of a voice sound at each microphone in a noisy environment, and hence not practical. For this reason the noise reduction apparatus 1 in this embodiment is equipped with the voice direction detector 12 for detecting a voice incoming direction, instead of obtaining the spatial acoustic characteristics CV1 and CV2.

The noise reduction apparatus 1 in this embodiment determines a voice incoming direction based on the phase difference between the sound picked-up signals 21 and 22 when it employs the voice direction detector 12a shown in FIG. 4.

In detail, there is a case of phase advance in which the phase of a voice component carried by the sound pick-up signal 21 is more advanced than the phase of a voice component carried by the sound pick-up signal 22. In this case, it is presumed that a sound source is located closer to the main microphone 111 than to the sub-microphone 112 (the pattern B). On the other hand, there is a case of phase delay in which the phase of a voice component carried by the sound pick-up signal 21 is more delayed than the phase of a voice component carried by the sound pick-up signal 22. In this case, it is presumed that a sound source is located closer to the sub-microphone 112 than to the main microphone 111. Moreover, there is a case in which the phase difference between a phase of a voice component carried by the sound pick-up signal 21 and a phase of a voice component carried by the sound pick-up signal 22 falls in the specific range (−T<phase difference<T), or the absolute value of the phase difference is smaller than the specific value T. In this case, it is presumed that a sound source is located, for example, at a position that exists on an imaginary vertical line extending from around a middle point between the main microphone 111 and the sub-microphone 112 (the pattern C in FIG. 7).

Moreover, the noise reduction apparatus 1 in this embodiment determines a voice incoming direction based on the power information on the sound picked-up signals 21 and 22 when it employs the voice direction detector 12b shown in FIG. 5.

In detail, there is a case in which a power value of the sound pick-up signal 21 is larger than a power value of the sound pick-up signal 22. In this case, it is presumed that a sound source is located closer to the main microphone 111 than to the sub-microphone 112 (the pattern B). On the other hand, there is a case in which a power value of the sound pick-up signal 21 is smaller than a power value of the sound pick-up signal 22. In this case, it is presumed that a sound source is located closer to the sub-microphone 112 than to the main microphone 111. Moreover, there is a case in which the power difference between a power value of the sound pick-up signal 21 and a power value of the sound pick-up signal 22 falls in the specific range (−P<power difference<P), or the absolute value of the power difference is smaller than the specific value P. In this case, it is presumed that a sound source is located at a position that exists on an imaginary vertical line extending from around a middle point between the main microphone 111 and the sub-microphone 112 (the pattern C in FIG. 7).

Through the detection of a voice incoming direction by the voice direction detector 12a or 12b, if the reduction in sound level is predicted for the output signal 29 after the noise reduction process, the noise reduction-amount adjuster 16 reduces the noise-presumed signal 25 to reduce a noise reduction amount in the noise reduction processor 13. With this process, the reduction in sound level is restricted for the output signal 29. In other words, the noise reduction-amount adjuster 16 reduces the term “H×CV2×V(t)” in the expression (13) in which the term expresses a voice component carried by the noise-presumed signal 25, to restrict the reduction in sound level of the output signal 29.

Accordingly, it is achieved by the noise reduction apparatus 1 of this embodiment to restrict the reduction in sound level of the output signal 29 while reducing a noise component carried by the sound picked-up signal (voice signal) 21.

There are several cases in which the reduction in sound level is predicted for the output signal 29 after the noise reduction process, such as, if a voice source is located at a position that exists on an imaginary vertical line extending from around a middle point between the main microphone 111 and the sub-microphone 112 (the pattern C in FIG. 7), and if a voice source is located at the sub-microphone 112 side, the opposite case of the pattern B in FIG. 7.

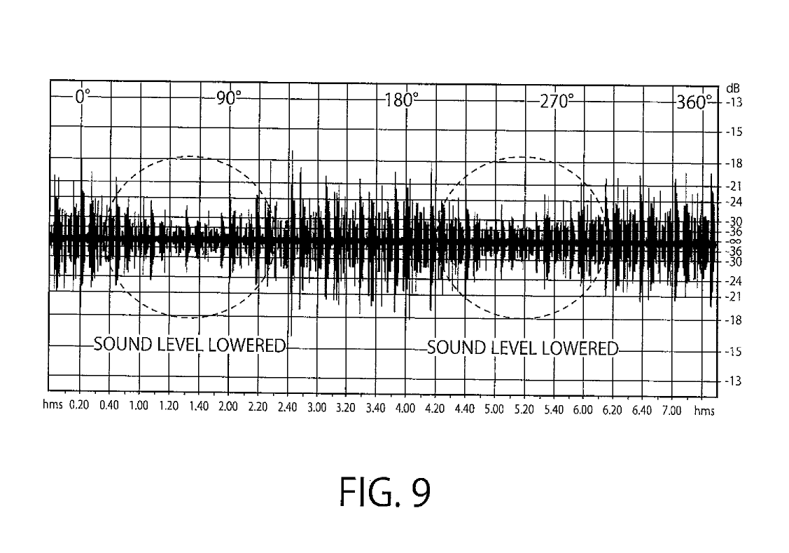

The relationship between the position of a voice source and the sound level of an output signal after a noise reduction process will be discussed with respect to FIGS. 9 to 11.

FIG. 9 is a view showing the relationship between the position of a voice source and the sound level of an output signal after a noise reduction process by a known noise reduction technique which will be described later.

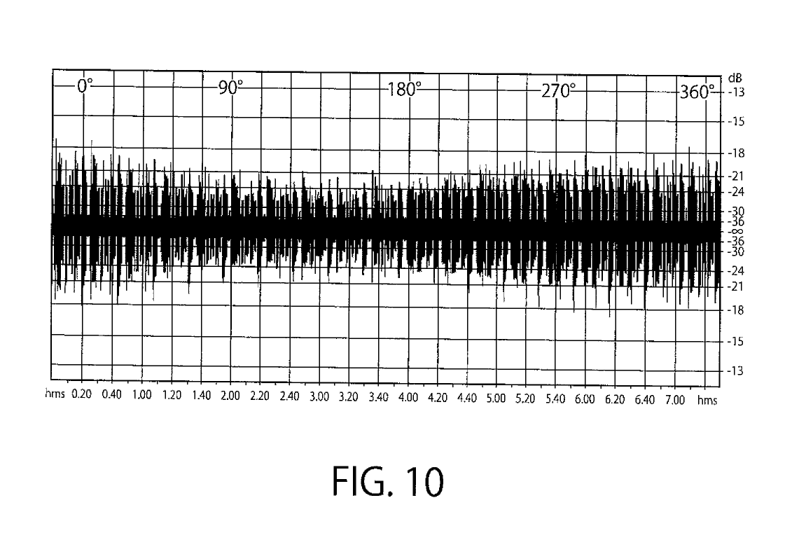

FIG. 10 is a view showing the relationship between the position of a voice source with respect to a main microphone and the sound level of a sound pick-up signal obtained based on a sound picked up by the main microphone. The main microphone and a sub-microphone are arranged so that they face in opposite directions in a similar manner as shown in FIG. 7. The position (angle) of the voice source with respect to the main microphone is: zero degrees when the voice source is located on an imaginary straight line connected between the main microphone and the sub-microphone and closer to the main microphone than to the sub-microphone; 180 degrees when the voice source is located on the imaginary straight line and closer to the sub-microphone than to the main microphone; and 90 or 270 degrees when the voice source is located on an imaginary vertical line extending from a middle point between the main microphone and the sub-microphone. FIGS. 9 and 10 show the result of sound level measurements on an output signal when a user (the voice source) moves around a known noise reduction apparatus by 360 degrees (the apparatus being located at the center) with a specific constant distance between the user and the apparatus while the user is speaking the same phrase. In the measurements in FIG. 9, the position of a noise source and that of the known noise reduction apparatus is fixed at a specific distance.

As shown in FIG. 10, when the voice source is located within a range from about 90 to 270 degrees (that is, it is located at the side- or rear-face side of the main microphone), slight reduction in sound level is observed due to the fact that the voice source does not face the front face of the main microphone and the distance between the voice source and a pickup provided on the front face of the main microphone is longer than the case in which the voice source faces the front face of the main microphone. However, the sound level of a sound pick-up signal obtained based on a voice picked up by the main microphone is not reduced so much, and hence the clearness of the voice sound is maintained.

On the contrary, as shown in FIG. 9, in the known noise reduction process, although the noise level is lowered entirely, the mixture of voice components with noise components in the sub-microphone is clearly observed.

A comparison is made between the waveforms in FIGS. 9 and 10. When the voice source is located at about 90 or 270 degrees with respect to the main microphone, that is, when the voice source is located at a position that exists on an imaginary vertical line extending from a middle point between the main microphone and the sub-microphone, the sound level of an output signal is lowered. This is because of the mixture of voice components with noise components in the sub-microphone when the voice source is located at about 90 or 270 degrees with respect to the main microphone, like the pattern C in FIG. 7.

FIG. 9 shows almost no reduction in sound level of the output signal even when the voice source is located at about 180 degrees with respect to the main microphone. However, the output signal at about 180 degrees carries a reverse-phase component (corresponding to the noise-presumed signal described in this embodiment) of a voice sound, and hence a reproduced voice sound may not be clearly heard. Although the angle at which a voice sound is attenuated depends on the direction of a noise source, the reduction in sound level and clearness of voice sounds are unavoidable due to the mixture of voice components with noise components in the sub-microphone.

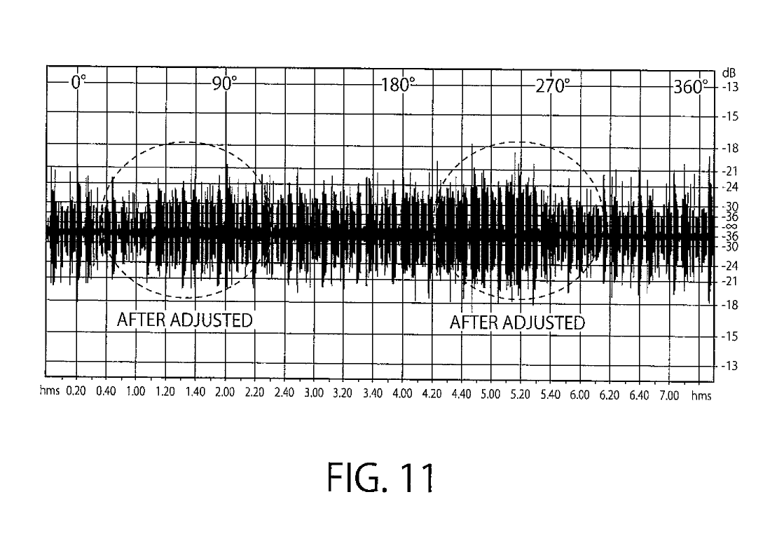

FIG. 11 is a view showing the relationship between the position of a voice source and the sound level of an output signal after the noise reduction process by the noise reduction apparatus 1 in this embodiment.

In the noise reduction apparatus 1 in this embodiment, as shown in FIG. 11, even when a voice source is located at about 90 or 270 degrees with respect to the main microphone 111, there is almost no remarkable reduction observed in sound level of the output signal. This is because, in the noise reduction apparatus 1 of this embodiment, the voice direction detector 12 determines a voice incoming direction. Then, if it is assumed that a voice source is located at, for example, about 90 or 270 degrees with respect to the main microphone 111, the voice direction detector 16 reduces the noise-presumed signal 25, thereby reducing the noise reduction amount in the noise reduction processor 13. With the noise reduction process by the noise reduction apparatus 1 in this embodiment, a voice sound level can be maintained at an almost constant level.

FIG. 12 shows exemplary noise reduction-amount adjustment values to be stored by the noise reduction-amount adjuster 16 with respect to the location of a voice source, in the noise reduction apparatus 1 of this embodiment. The noise reduction-amount adjuster 16 looks up the noise reduction-amount adjustment values in accordance with a voice incoming direction (the location of a sound source) determined by the voice direction detector 12 to decide a noise reduction-amount adjustment value to be multiplied to the noise-presumed signal 25.

The position (location) of the a voice source corresponds to the angle of incidence of a voice sound and to the phase or power difference between the sound picked-up signals 21 and 22. The noise reduction-amount adjustment value is, for example, in the range from 0 to 1. The noise reduction-amount adjuster 16 multiplies the noise-presumed signal 25 by a noise reduction-amount adjustment value, for example, in the range from 0 to 1 to adjust the magnitude of the noise-presumed signal 25. When the noise reduction-amount adjustment value is 1, the noise reduction-amount adjuster 16 outputs the noise-presumed signal 25 with no adjustment, as the noise-presumed signal 28. When the noise reduction-amount adjustment value is 0, the noise reduction-amount adjuster 16 outputs no noise-presumed signal (no noise reduction process performed).

In FIG. 12, the noise reduction-amount adjustment value is set to a smaller value as a voice source moves from the main microphone side to the sub-microphone side. In detail, the noise reduction-amount adjustment value is set to a smaller value gradually as the voice source moves from the position at about 60 degrees to the position at about 90 degrees, and also from the position at about 300 degrees to the position at about 270 degrees. The noise reduction-amount adjustment value is set to about 0.2 in the range from about 90 to 270 degrees.

When the voice incoming-direction information 24 (the phase or power difference) varies rapidly, the noise reduction-amount adjustment value also varies rapidly, resulting in rapid change in the noise-presumed signal 25. This results in that the sound level of the output signal varies rapidly so that a user may hear a strange or uncomfortable sound. In order to avoid such a problem, a process of restricting the rapid change in the noise reduction-amount adjustment value, that is, the rapid change in the noise-presumed signal 25, may be performed using a specific time constant. The restriction process may be performed in accordance with the following expression (14)

A=Abase×(1/Tc)+Alast×(Tc−1)/Tc) (14)

where Abase is a noise reduction-amount adjustment value, A is a reference noise reduction-amount adjustment value after the restriction process, and Alast is a noise reduction-amount adjustment value just before the restriction process.

As already discussed, in the known technique, a noise component carried by a voice signal is eliminated by subtracting a noise signal obtained by a microphone for picking up mainly noise sounds from a voice signal obtained by a microphone for picking up mainly voice sounds. In the case of noise reduction using a voice signal that mainly carries voice sounds and a noise signal that mainly carries noise components may cause mixing of voice components into the noise signal, depending on an environment where the noise reduction is performed. The mixture of the voice components into the noise signal may further cause cancellation of voice sounds carried by the voice signal in addition to the noise components, resulting in reduction in sound level of an signal after the noise reduction.

A mobile wireless communication apparatus, such as a transceiver, may be used in an environment with much noise, for example, a factory with a sound of a machine, a busy street and an intersection, hence requiring reduction of noises picked up by a microphone. Especially, a transceiver may be used in such a manner that a user listens to a sound from a speaker attached to the transceiver while the speaker is apart from a user's ear. Moreover, mostly users hold a transceiver apart from his or her body and hold it in a variety of ways.

A speaker microphone having a pickup unit (a microphone) and a reproduction unit (a speaker) apart from a transceiver body can be used in a variety of ways. For example, a microphone can be slung over a user's neck or placed on a user's shoulder so that users can speak without facing the microphone. Moreover, a user may speak from a direction closer to the rear face of a microphone than to the front face having a pickup. It is thus not always the case that a voice sound reaches a speaker microphone from an appropriate direction, for example, the direction towards the microphone.

As discussed above, the noise reduction process using an adaptive filter for an apparatus such as a transceiver (a mobile wireless communication apparatus, an audio input apparatus, etc.) requires a technique to restrict the reduction in sound level of a voice signal due to the mixture of voice components with noise components carried by a sound pick-up signal obtained based on a sound picked up by a sub-microphone.

There is a known technique to maintain the clearness of a voice sound with detection of cancelation of voice components in accordance with the change in adaptive coefficients of an adaptive filter. In this known noise reduction technique, there are provided a main microphone that picks up a sound that mainly includes a voice component and a sub-microphone that picks up a sound that mainly includes a noise component and exhibits low sensitivity in a voice incoming direction. When a sound component in a direction near to a voice incoming direction is generated as a noise cancellation signal in a process of the adaptive filter, the gain factor that affects the entire adaptive coefficients is adjusted to restrict the filtering process to prevent the reduction in sound level of a voice component.

However, in the known noise reduction technique explained above, it is a precondition that there is a voice source at the main microphone side. Moreover, the known technique employs a sub-microphone that exhibits a directivity. It is therefore difficult to apply the known noise reduction technique to a transceiver in which a voice component may be mixed with a noise component at a sub-microphone that picks up a sound that mainly includes a noise component.

In another known noise reduction technique using an adaptive filter, the sound level of an error signal or an input signal is adjusted to prevent the reduction in sound level of a voice component. In detail, in order to maintain a voice sound level, the sound level of an error signal that is a noise signal or of an input signal (including a delayed signal) into which a noise signal is mixed is controlled. Accordingly, in the known noise reduction technique, although a voice sound level is maintained, a noise reduction effect is not effective.

Moreover, in the other known noise reduction technique using an adaptive filter, a noise cancellation process is performed by filtering by using signals directly input to the adaptive filter with generation of a noise cancellation signal with no noise-reduction amount adjustment. Therefore, a voice component mixed into a signal to be used in the noise cancellation process affects the process so that it is difficult to reduce a noise signal during a speech segment. Moreover, an error signal is added to the output signal of the adaptive filter. However, mere addition of an error signal to the output signal of the adaptive filter or to an input signal cannot provide an excellent noise reduction effect with almost no improvement in clearness of voices.

Accordingly, in the known noise reduction techniques explained above, it is difficult to maintain the voice sound level.

On the contrary, in the noise reduction apparatus 1 in this embodiment, a noise reduction amount is adjusted by the noise reduction processor 13 in accordance with a voice incoming direction determined by the voice direction detector 12. In detail, a noise reduction amount is reduced by the noise reduction processor 13 when it is assumed that a voice source is located, for example, at a position that exists on an imaginary vertical line extending from around a middle point between the main microphone 111 and the sub-microphone 112 (the pattern C in FIG. 7) or located at the sub-microphone 112 side. In this way, the reduction of a voice sound level at the output signal 29 after the noise reduction process is restricted.

Moreover, in the noise reduction apparatus 1 in this embodiment, the adders 17 and 18 are provided separately, as shown in FIG. 1. Therefore, the feedback signal (an error signal) 26 required for update of the adaptive coefficients of the adaptive filter 14 is not affected by noise reduction amount adjustments at the noise reduction-amount adjuster 16. Accordingly, the adaptive coefficients of the adaptive filter 14 can be updated any time so as to be adapted to noise signals, hence the adaptive filter 14 can almost always exhibit its maximum performance. In this way, a noise reduction process can be effectively performed even if there are a plurality of speakers (people) or there are a plurality of voice incoming directions, as long as the positions of the speakers meets the requirements discussed above with respect to FIG. 7. Moreover, even if the position of a speaker does not meet the requirements, the voice sound level can be maintained by reducing the noise reduction amount at the noise reduction processor 13 in accordance with the voice incoming-direction information 24. Accordingly, the noise reduction apparatus 1 in this embodiment achieves higher voice clearness with an excellent noise reduction effect in various environments.

Explained next is an audio input apparatus having the noise reduction apparatus 1 installed therein according to the present invention.

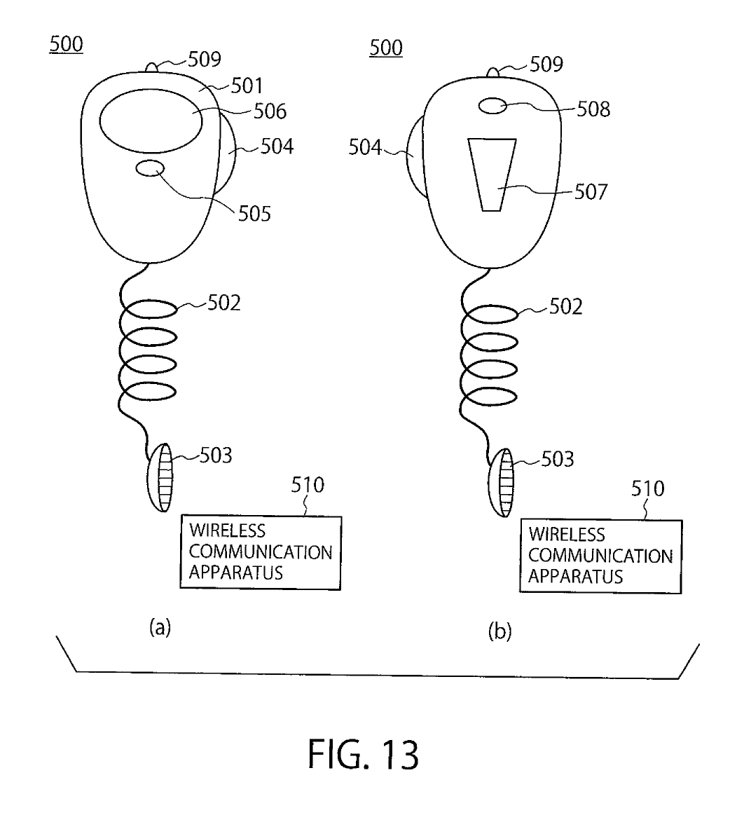

FIG. 13 is a schematic illustration of an audio input apparatus 500 having the noise reduction apparatus 1 installed therein, with views (a) and (b) showing the front and rear faces of the audio input apparatus 500, respectively.

As shown in FIG. 13, the audio input apparatus 500 is detachably connected to a wireless communication apparatus 510. The wireless communication apparatus 510 is used for wireless communication at a specific frequency. When a user speaks into the audio input apparatus 500, his or her voice is input to the wireless communication apparatus 500.

The audio input apparatus 500 has a main body 501 equipped with a cord 502 and a connector 503. The main body 501 is formed having a specific size and shape so that a user can grab it with no difficulty. The main body 501 houses several types of parts, such as, a microphone, a speaker, an electronic circuit, and the noise reduction apparatus 1 of the present invention.

As shown in the view (a) of FIG. 13, a main microphone 505 and a speaker 506 are provided on the front face of the main body 501. Provided on the rear face of the main body 501 are a belt clip 507 and a sub-microphone 508, as shown in the view (b) of FIG. 13. Provided at the top and the side of the main body 501 are an LED 509 and a PTT (Push To Talk) unit 504, respectively. The LED 509 informs a user of the user's voice pick-up state detected by the audio input apparatus 500. The PTT unit 504 has a switch that is pushed into the main body 501 to switch the wireless communication apparatus 510 into a speech transmission state.

The noise reduction apparatus 1 according to the embodiment is installed in the audio input apparatus 500. The main microphone 111 and the sub-microphone 112 (FIG. 8) of the noise reduction apparatus 1 correspond to the main microphone 505 shown in the view (a) of FIG. 13 and the sub-microphone 508 shown in the view (b) of FIG. 13, respectively.

The output signal 29 (FIG. 1) output from the noise reduction apparatus 1 is supplied from the audio input apparatus 500 to the wireless communication apparatus 510 through the cord 502. The wireless communication apparatus 510 can transmit a low-noise voice sound to another wireless communication apparatus when the output signal 29 supplied thereto is a signal output after the noise reduction process is performed.

Explained next is a wireless communication apparatus (a transceiver, for example) having the noise reduction apparatus 1 installed therein according to the present invention.

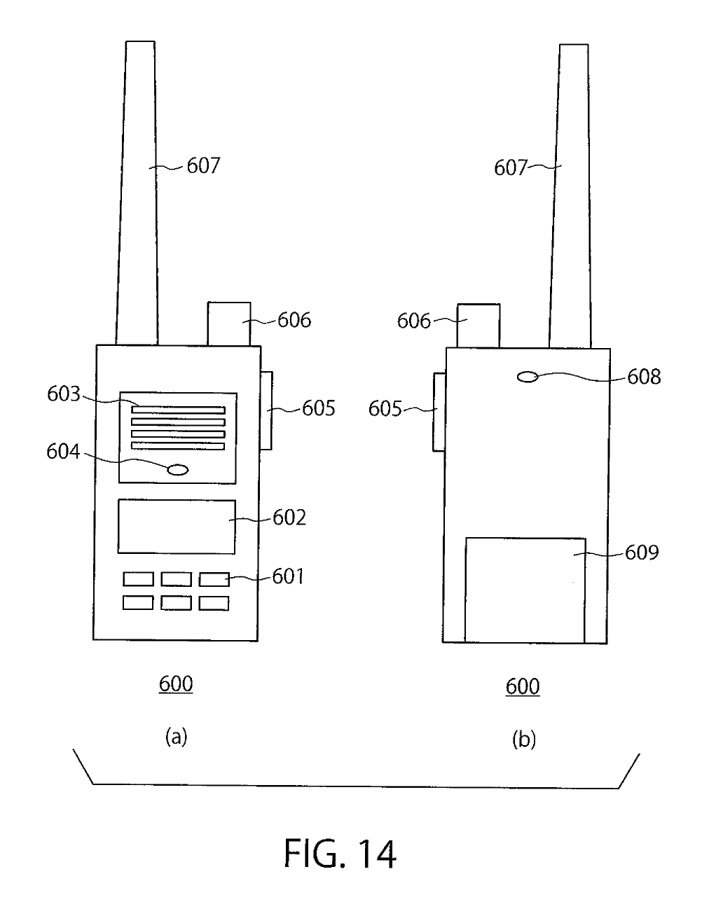

FIG. 14 is a schematic illustration of a wireless communication apparatus 600 having the noise reduction apparatus 1 installed therein, with views (a) and (b) showing the front and rear faces of the wireless communication apparatus 600, respectively.

The wireless communication apparatus 600 is equipped with input buttons 601, a display screen 602, a speaker 603, a main microphone 604, a PTT (Push To Talk) unit 605, a switch 606, an antenna 607, a sub-microphone 608, and a cover 609.

The noise reduction apparatus 1 is installed in the wireless communication apparatus 600. The main microphone 111 and the sub-microphone 112 (FIG. 8) of the noise reduction apparatus 1 correspond to the main microphone 604 shown in the view (a) of FIG. 14 and the sub-microphone 608 shown in the view (b) of FIG. 14, respectively.

The output signal 29 (FIG. 1) output from the noise reduction apparatus 1 undergoes a high-frequency process by an internal circuit of the wireless communication apparatus 600 and is transmitted via the antenna 607 to another wireless communication apparatus. The wireless communication apparatus 600 can transmit a low-noise voice sound to another wireless communication apparatus when the output signal 29 supplied thereto is a signal output after the noise reduction process is performed.

The noise reduction apparatus 1 starts the noise reduction process when a user depresses the PTT unit 605 for the start of sound transmission and halts the noise reduction process when the user detaches a finger from the PTT unit 605 for the completion of sound transmission.

As described above in detail, the present invention provide a noise reduction apparatus, an audio input apparatus, a wireless communication apparatus, and a noise reduction method that can restrict the reduction in sound level.

It is further understood by those skilled in the art that the foregoing description is a preferred embodiment of the disclosed device or method and that various changes and modifications may be made in the invention without departing from the spirit and scope thereof.

What is claimed is:

1. A noise reduction apparatus comprising:
a speech segment determiner configured to detect a speech segment of a voice sound based on a first sound pick-up signal obtained based on the voice sound;
a voice direction detector configured to determine a voice incoming direction of the voice sound using the first sound pick-up signal and a second sound pick-up signal obtained based on a picked-up sound; and
a noise reduction processor configured to perform a noise reduction process to reduce a noise component carried by the first sound pick-up signal by using the second sound pick-up signal,
wherein a noise reduction amount adjusted in accordance with the voice incoming direction is used in the noise reduction process.

2. The noise reduction apparatus according to claim 1, wherein the noise reduction processor includes:
an adaptive filter configured to generate a noise-presumed signal corresponding to the noise component carried by the first sound pick-up signal by using the second sound pick-up signal;
an adaptive coefficient adjuster configured to adjust adaptive coefficients of the adaptive filter based on a result of an arithmetic operation between the first and second sound pick-up signals;
a noise reduction-amount adjuster configured to adjust the noise-presumed signal in accordance with the voice incoming direction; and
an arithmetic unit configured to reduce the noise component carried by the first sound pick-up signal by using the noise-presumed signal adjusted by the noise reduction-amount adjuster and the first sound pick-up signal.

3. The noise reduction apparatus according to claim 1, wherein the voice direction detector determines the voice incoming direction of the voice based on a phase difference between the first and sound pick-up signals.

4. The noise reduction apparatus according to claim 3, wherein the voice direction detector calculates the phase difference based on a cross-correlation value obtained by using a first group of sampled signals each corresponding to the first sound pick-up signal and a second group of sampled signals each corresponding to the second sound pick-up signal, either one of the first and second groups being used as reference signals and the other of the first and second groups being used as comparison signals.

5. The noise reduction apparatus according to claim 3, wherein the noise reduction processor reduces the noise reduction amount when at least either one of a first case and a second case is established, the first case being a case in which the phase difference is within a predetermined range and the second case being a case in which a phase of the first sound pick-up signal is more delayed than a phase of the second sound pick-up signal.

6. The noise reduction apparatus according to claim 1, wherein the voice direction detector detects the voice incoming direction based on a power difference between magnitudes of the first and second sound pick-up signals.

7. The noise reduction apparatus according to claim 6, wherein the noise reduction processor reduces the noise reduction amount when at least either one of a first case and a second case is established, the first case being a case in which the power difference is within a predetermined range and the second case being a case in which the magnitude of the first sound pick-up signal is smaller than the magnitude of the second sound pick-up signal.

8. The noise reduction apparatus according to claim 1, wherein the voice direction detector detects the voice incoming direction based on a phase difference between the first and second sound pick-up signals and a power difference between magnitudes of the first and second sound pick-up signals.

9. The noise reduction apparatus according to claim 1, wherein the noise reduction-amount adjuster adjusts the noise-presumed signal by multiplying the noise-presumed signal by a noise reduction-amount adjustment value in a range from 0 to 1 in accordance with the voice incoming direction.

10. The noise reduction apparatus according to claim 9, wherein the noise reduction-amount adjuster restricts rapid change in the noise-presumed signal when adjusting the noise-presumed signal.

11. The noise reduction apparatus according to claim 1, wherein the speech segment determiner determines the speech segment when a feature value that indicates a feature of a voice component carried by the first sound pick-up signal is equal to or larger than a specific threshold value.

12. The noise reduction apparatus according to claim 1, wherein the speech segment determiner detects the speech segment when a signal-to-noise ratio between a peak level of a vowel-sound frequency component of a voice component carried by the first sound pick-up signal and a noise level set in each frequency band is at least a specific ratio for at least a specific number of peaks.

13. The noise reduction apparatus according to claim 1, wherein the speech segment determiner detects the speech segment when a spectral pattern of a consonant of a voice component carried by the first sound pick-up signal in each specific frequency band rises as the specific frequency band rises.

14. An audio input apparatus comprising:
a first face and an opposite second face that is apart from the first face with a specific distance;
a first microphone and a second microphone provided on the first face and the second face, respectively;
a speech segment determiner configured to detect a speech segment of a voice sound based on a first sound pick-up signal obtained based on the voice sound picked up by the first microphone;
a voice direction detector configured to determine a voice incoming direction of the voice sound using the first sound pick-up signal and a second sound pick-up signal obtained based on a sound picked up by the second microphone; and
a noise reduction processor configured to perform a noise reduction process to reduce a noise component carried by the first sound pick-up signal by using the second sound pick-up signal,
wherein a noise reduction amount adjusted in accordance with the voice incoming direction is used in the noise reduction process.

15. A wireless communication apparatus comprising:
a first face and an opposite second face that is apart from the first face with a specific distance;
a first microphone and a second microphone provided on the first face and the second face, respectively;
a speech segment determiner configured to detect a speech segment of a voice sound based on a first sound pick-up signal obtained based on the voice sound picked up by the first microphone;
a voice direction detector configured to determine a voice incoming direction of the voice sound using the first sound pick-up signal and a second sound pick-up signal obtained based on a sound picked up by the second microphone; and
a noise reduction processor configured to perform a noise reduction process to reduce a noise component carried by the first sound pick-up signal by using the second sound pick-up signal,
wherein a noise reduction amount adjusted in accordance with the voice incoming direction is used in the noise reduction process.

16. A noise reduction method comprising the steps of:
detecting a speech segment of a voice sound based on a first sound pick-up signal obtained based on the voice sound;
determining a voice incoming direction of the voice sound using the first sound pick-up signal and a second sound pick-up signal obtained based on a picked-up sound; and
performing a noise reduction process to reduce a noise component carried by the first sound pick-up signal by using the second sound pick-up signal, wherein a noise reduction amount adjusted in accordance with the voice incoming direction is used in the noise reduction process.
